(19) United States
(12) Patent Application Publication
(10) Pub. No.: US 2021/0383804 A1
(43) Pub. Date: Dec. 9, 2021

(54) IMMERSIVE COLLABORATION OF REMOTE PARTICIPANTS VIA MEDIA DISPLAYS

(71) Applicant: View, Inc., Milpitas, CA (US)

(72) Inventors: Tanya MAKKER, Milpitas, CA (US); Nitesh TRIKHA, Pleasanton, CA (US); Brian Lee SMITH, Benicia, CA (US); Keivan EBRAHIMI, Fremont, CA (US); Todd Daniel ANTES, San Jose, CA (US); Aditya DAYAL, Sunnyvale, CA (US); Amit SARIN, Milpitas, CA (US)

(21) Appl. No.: 17/300,303

(22) Filed: Apr. 29, 2021

Related U.S. Application Data
(63) Continuation-in-part of application No. PCT/US21/27418, filed on Apr. 15, 2021.
Application No. PCT/US21/27418 is a continuation-in-part of application No. 17/249,148, filed on Feb. 22, 2021.
Application No. 17/249,148 is a continuation of application No. 16/096,557, filed on Oct. 25, 2018, now Pat. No. 10,964,320.
Application No. 16/096,557 is a continuation-in-part of application No. 16/948,947, filed on Oct. 7, 2020.
Application No. 16/948,947 is a continuation of application No. 16/462,916, filed on May 21, 2019, now Pat. No. 11,137,659.
Application No. 16/462,916 is a continuation of application No. 16/082,793, filed on Sep. 6, 2018, now Pat. No. 10,935,864.
Application No. 16/082,793 is a continuation-in-part of application No. 16/950,774, filed on Nov. 17, 2020.
Application No. 16/950,774 is a continuation of application No. 16/608,157, filed on Oct. 24, 2019.
Application No. 16/608,157 is a continuation-in-part of application No. 17/083,128, filed on Oct. 28, 2020.
Application No. 17/083,128 is a continuation of application No. 16/664,089, filed on Oct. 25, 2019.
Application No. 16/664,089 is a continuation-in-part of application No. PCT/US2019/030467, filed on May 2, 2019.
Application No. 16/664,089 is a continuation-in-part of application No. PCT/US2018/029460, filed on Apr. 25, 2018.
Application No. PCT/US2018/029460 is a continuation-in-part of application No. 17/081,809, filed on Oct. 27, 2020.
Application No. 17/081,809 is a continuation of application No. 16/608,159, filed on Oct. 24, 2019.
Application No. 16/608,159 is a continuation-in-part of application No. PCT/US20/53541, filed on Sep. 30, 2020.
(60) Provisional application No. 63/080,899, filed on Sep. 21, 2020.
(60) Provisional application No. 63/052,639, filed on Jul. 16, 2020.
(60) Provisional application No. 63/010,977, filed on Apr. 16, 2020.
(60) Provisional application No. 62/327,880, filed on Apr. 26, 2016.
(60) Provisional application No. 62/607,618, filed on Dec. 19, 2017.
(60) Provisional application No. 62/523,606, filed on Jun. 22, 2017.
(60) Provisional application No. 62/507,704, filed on May 17, 2017.
(60) Provisional application No. 62/506,514, filed on May 15, 2017.
(60) Provisional application No. 62/490,457, filed on Apr. 26, 2017.
(60) Provisional application No. 62/666,033, filed on May 2, 2018.
(60) Provisional application No. 62/490,457, filed on Apr. 26, 2017.
(60) Provisional application No. 62/506,514, filed on May 15, 2017.
(60) Provisional application No. 62/507,704, filed on May 17, 2017.
(60) Provisional application No. 62/523,606, filed on Jun. 22, 2017.
(60) Provisional application No. 62/607,618, filed on Dec. 19, 2017.
(60) Provisional application No. 62/607,618, filed on Dec. 19, 2017.
(60) Provisional application No. 62/523,606, filed on Jun. 22, 2017.
(60) Provisional application No. 62/507,704, filed on May 17, 2017.
(60) Provisional application No. 62/506,514, filed on May 15, 2017.
(60) Provisional application No. 62/490,457, filed on Apr. 26, 2017.
(60) Provisional application No. 62/911,271, filed on Oct. 5, 2019.
(60) Provisional application No. 62/952,207, filed on Dec. 20, 2019.
(60) Provisional application No. 62/975,706, filed on Feb. 12, 2020.
(60) Provisional application No. 63/085,254, filed on Sep. 30, 2020.
(60) Provisional application No. 63/170,245, filed on Apr. 2, 2021.
(60) Provisional application No. 63/154,352, filed on Feb. 26, 2021.
(60) Provisional application No. 63/115,842, filed on Nov. 19, 2020.

(51) Int. Cl. G10L 15/22; G06F 21/32; E06B 3/67; E06B 9/24; G02F 1/163; G06F 3/0488; G06F 3/16; G10L 15/26

(52) U.S. Cl. CPC G10L 15/22; G06F 21/32; E06B 3/6722; E06B 9/24; G02F 1/163; G06F 2203/0381; G06F 3/16; G10L 15/26; G06F 3/04886; G10L 2015/223; E06B 2009/2464; G06F 3/04883

(57) ABSTRACT

An immersive digital experience for video conferencing simulates common presence of a virtual participant in a local environment. Such simulation may include (i) using a transparent media display having a portion of its pixels projecting the virtual participant's body image while keeping at least a portion of the background transparent (e.g., to visible light), (ii) disposing sensor(s) (e.g., camera) behind the transparent media display at the gaze of the participant, and/or (iii) using added virtual overlays (e.g., of plants, memorabilia, and/or furniture) to the virtual image (e.g., that are consistent with the local environment), e.g., to provide a sense of depth ranging from the overlays to the virtual participant projection and to the background showing through the transparent media display.

### CROSS REFERENCE TO RELATED APPLICATIONS

This application relates to International Patent Application Serial No. PCT/US21/27418, filed Apr. 15, 2021, titled “INTERACTION BETWEEN AN ENCLOSURE AND ONE OR MORE OCCUPANTS,” that claims priority from U.S. Provisional Patent Application Ser. No. 63/080,899, filed Sep. 21, 2020, titled “INTERACTION BETWEEN AN ENCLOSURE AND ONE OR MORE OCCUPANTS,” to U.S. Provisional Application Ser. No. 63/052,639, filed Jul. 16, 2020, titled “INDIRECT INTERACTIVE INTERACTION WITH A TARGET IN AN ENCLOSURE,” and to U.S. Provisional Application Ser. No. 63/010,977, filed Apr. 16, 2020, titled “INDIRECT INTERACTION WITH A TARGET IN AN ENCLOSURE.” This application is also related as a Continuation-in-Part of U.S. patent application Ser. No. 17/249,148, filed Feb. 22, 2021, titled “CONTROLLING OPTICALLY-SWITCHABLE DEVICES,” which is a Continuation of U.S. patent application Ser. No. 16/096,557, filed Oct. 25, 2018, titled “CONTROLLING OPTICALLY-SWITCHABLE DEVICES,” which is a National Stage Entry of International Patent Application Serial No. PCT/US17/29476, filed Apr. 25, 2017, titled “CONTROLLING OPTICALLY-SWITCHABLE DEVICES,” which claims priority from U.S. Provisional Application Ser. No. 62/327,880, filed Apr. 26, 2016, titled “CONTROLLING OPTICALLY-SWITCHABLE DEVICES,” which is a Continuation-in-Part of U.S. patent application Ser. No. 14/391,122, filed Oct. 7, 2014, now U.S. Pat. No. 10,365,531, issued Jul. 30, 2019, titled “APPLICATIONS FOR CONTROLLING OPTICALLY SWITCHABLE DEVICES,” which is a National Stage Entry of International Patent Application Serial No. PCT/US13/36456, filed Apr. 12, 2013, titled “APPLICATIONS FOR CONTROLLING OPTICALLY SWITCHABLE DEVICES,” which claims priority from U.S. Provisional Application Ser. No. 61/624,175, filed Apr. 13, 2012, titled “APPLICATIONS FOR CONTROLLING OPTICALLY SWITCHABLE DEVICES.” This application is also related as a Continuation-in-Part of U.S. patent application Ser. No. 16/946,947, filed Jul. 13, 2020, titled “AUTOMATED COMMISSIONING OF CONTROLLERS IN A WINDOW NETWORK,” which is a Continuation of U.S. patent application Ser. No. 16/462,916, filed May 21, 2019, titled “AUTOMATED COMMISSIONING OF CONTROLLERS IN A WINDOW NETWORK,” which is a Continuation of U.S. patent application Ser. No. 16/082,793, filed Sep. 6, 2018, and issued as U.S. Pat. No. 10,935,864 on Mar. 1, 2021, titled “METHOD OF COMMISSIONING ELECTROCHROMIC WINDOWS,” U.S. patent application Ser. No. 16/462,916, filed May 21, 2019, titled “AUTOMATED COMMISSIONING OF CONTROLLERS IN A WINDOW NETWORK,” is also a National Stage Entry of International Patent Application Serial No. PCT/US17/62634, filed Nov. 20, 2017, titled “AUTOMATED COMMISSIONING OF CONTROLLERS IN A WINDOW NETWORK,” which claims priority from U.S. Provisional Patent Application Ser. No. 62/551,649, filed Aug. 29, 2017, titled “AUTOMATED COMMISSIONING OF CONTROLLERS IN A WINDOW NETWORK,” and from U.S. Provisional Patent Application Ser. No. 62/426,126, filed Nov. 23, 2016, titled “AUTOMATED COMMISSIONING OF CONTROLLERS IN A WINDOW NETWORK.” This application is also related as a Continuation-in-Part of U.S. patent application Ser. No. 16/950,774, filed Nov. 17, 2020, titled “DISPLAYS FOR TINTABLE WINDOWS,” which is a Continuation of U.S. patent application Ser. No. 16/608,157, filed Oct. 24, 2019, titled “DISPLAYS FOR TINTABLE WINDOWS,” which is a National Stage Entry of International Patent Application Serial No. PCT/US18/29476, filed Apr. 25, 2018, titled “DISPLAYS FOR TINTABLE WINDOWS,” which claims priority to (i) U.S. Provisional Patent Application Ser. No. 62/607,618, filed Dec. 19, 2017, titled “ELECTROCHROMIC WINDOWS WITH TRANSPARENT DISPLAY TECHNOLOGY FIELD,” (ii) U.S. Provisional Patent Application Ser. No. 62/523,606, filed Jun. 22, 2017, titled “ELECTROCHROMIC WINDOWS WITH TRANSPARENT DISPLAY TECHNOLOGY,” (iii) U.S. Provisional Patent Application Ser. No. 62/507,704, filed May 17, 2017, titled “ELECTROCHROMIC WINDOWS WITH TRANSPARENT DISPLAY TECHNOLOGY,” (iv) U.S. Provisional Patent Application Ser. No. 62/506,514, filed May 15, 2017, titled “ELECTROCHROMIC WINDOWS WITH TRANSPARENT DISPLAY TECHNOLOGY,” and (v) U.S. Provisional Patent Application Ser. No. 62/490,457, filed Apr. 26, 2017, titled “ELECTROCHROMIC WINDOWS WITH TRANSPARENT DISPLAY TECHNOLOGY.” This application is also related as a Continuation-In-Part of U.S. patent application Ser. No. 17/083,128, filed Oct. 28, 2020, titled “BUILDING NETWORK,” which is a Continuation of U.S. patent application Ser. No. 16/664,089, filed Oct. 25, 2019, titled “BUILDING NETWORK,” that is a National Stage Entry of International Patent Application Serial No. PCT/US19/30467, filed May, 2, 2019, titled “EDGE NETWORK FOR BUILDING SERVICES,” which claims priority to U.S. Provisional Patent Application Ser. No. 62/666,033, filed May 2, 2018, U.S. patent application Ser. No. 17/083,128, is also a Continuation-In-Part of International Patent Application Serial No. PCT/US18/29460, filed Apr. 25, 2018, that claims priority to U.S. Provisional Patent Application Ser. No. 62/607,618, to U.S. Provisional Patent Application Ser. No. 62/523,606, to U.S. Provisional Patent Application Ser. No. 62/507,704, to U.S. Provisional Patent Application Ser. No. 62/506,514, and to U.S. Provisional Patent Application Ser. No. 62/490,457. This application is also related as a Continuation-In-Part of U.S. patent application Ser. No. 17/081,809, filed Oct. 27, 2020, titled “TINTABLE WINDOW SYSTEM COMPUTING PLATFORM,” which is a Continuation of U.S. patent application Ser. No. 16/608,159, filed Oct. 24, 2019, titled “TINTABLE WINDOW SYSTEM COMPUTING PLATFORM,” that is a National Stage Entry of International Patent Application Serial No. PCT/US18/29406, filed Apr. 25, 2018, titled “TINTABLE WINDOW SYSTEM COMPUTING PLATFORM,” which claims priority to U.S. Provisional Patent Application Ser. No. 62/607,618, U.S. Provisional Patent Application Ser. No. 62/523,606, U.S. Provisional Patent Application Ser. No. 62/507,704, U.S. Provisional Patent Application Ser. No. 62/506,514, and U.S. Provisional Patent Application Ser. No. 62/490,457. This application is also related as a Continuation-In-Part of International Patent Application Serial No. PCT/US20/53641, filed Sep. 30, 2020, titled “TANDEM VISION WINDOW AND MEDIA DISPLAY,” which claims priority to U.S. Provisional Patent Application Ser. No. 62/911,271, filed Oct. 5, 2019, titled “TANDEM VISION WINDOW AND TRANSPARENT DISPLAY,” to U.S. Provisional Patent Application Ser. No. 62/952,207, filed Dec. 20, 2019, titled “TANDEM VISION WINDOW AND TRANSPARENT DISPLAY,” to U.S. Provisional Patent Application Ser. No. 62/975,706, filed Feb. 12, 2020, titled “TANDEM VISION WINDOW AND MEDIA DISPLAY,” to U.S. Provisional Patent Application Ser. No. 63/085,254, filed Sep. 30, 2020, titled “TANDEM VISION WINDOW AND MEDIA DISPLAY.” This application is also related as a Continuation-In-Part of U.S. Provisional Patent Application Ser. No. 63/170,245, filed Apr. 2, 2021, titled “DISPLAY CONSTRUCT FOR MEDIA PROJECTION AND WIRELESS CHARGING,” of U.S. Provisional Patent Application Ser. No. 63/154,352, filed Feb. 26, 2021, titled “DISPLAY CONSTRUCT FOR MEDIA PROJECTION AND WIRELESS CHARGING,” and of U.S. Provisional Patent Application Ser. No. 63/115,842, filed Nov. 19, 2020, titled “DISPLAY CONSTRUCT FOR MEDIA PROJECTION.” Each of the above recited patent applications is entirely incorporated herein by reference.

### BACKGROUND

This disclosure relates generally to improved digital experience that provides users an enhanced immersive experience, which simulates common presence of a virtual participant (and optional related virtual auxiliary content) and physically present participants in a conference.

Various facilities (e.g., buildings) have windows installed, e.g., in their facades. The windows provide a way to view an environment external to the facility. In some facilities, the window may take a substantial portion (e.g., more than about 30%, 40%, 50%, or 80% of a surface area) of a facility facade. Users may request utilization of at least a portion of the window surface area to view various media. The media may be for entertainment, educational, safety, health, and/or work purposes. The media may facilitate processing, presenting, and/or sharing data. the media may be or the purpose of conducting a conference such as in the form of a video conference with one or more remote parties. At times, a user may want to optimize usage of an interior space of the facility to visualize the media (e.g., by using the window surface area). The media may comprise an electronic media, digital media, and/or optical media. A user may request viewing the media with an ability to view through at least a portion of the window (e.g., with minimal impact on visibility through the window). The media may be displayed via a display that is at least partially transparent (e.g., to visible light). At times viewing the media may require a tinted (e.g., darker) backdrop. At times, a user may want to augment external views and/or projections of the display with overlays, augmented reality, and/or lighting.

At times, interactions over conventional video conferencing feel unnatural and/or distant. For example, it may be difficult to make pupil to pupil eye contact, e.g., because of the arrangement of each of the cameras being offset from the direction of the participants' gaze toward the display. The image may appear flat and/or detached from the real surrounding. Surroundings of the participant at the other end of a video conference may be disjointed from a local surroundings. When auxiliary text and/or graphic materials are shared and displayed by participant(s) at a first location, live updating of the materials has required cumbersome passing of control over the content from participant(s) at a first location to participant(s) at a distant second location (e.g., at another room, another building, or otherwise at another facility).

The user interaction may occur by way of media display construct(s) and imaging device(s). The imaging device may be associated with one or more interactive targets in an enclosure. The interactive target(s) can comprise an optically switchable device (e.g., tintable window of a facility), projected media, environmental appliance, sensor, emitter, and/or any other apparatus that is communicatively coupled to a network in an enclosure, which network facilitates power and/or communication.

In some embodiments, included in these device(s) are optically switchable window(s). The development and deployment of optically switchable windows for enclosures (e.g., buildings and other facilities) have increased as considerations of energy efficiency and system integration gain momentum. Electrochromic windows are a promising class of optically switchable windows. Electrochromism is a phenomenon in which a material exhibits a reversible electrochemically-mediated change in one or more optical properties when stimulated to a different electronic state. Electrochromic materials and the devices made from them may be incorporated into, for example, windows for home, commercial, or other use. The color, shade, hue, tint, transmittance, absorbance, and/or reflectance of electrochromic windows can be changed, e.g., by inducing a change in the electrochromic material. For example, by applying a voltage across the electrochromic material. Such capabilities can allow for control over the intensities of various (e.g., visible light) wavelengths of light that may pass through the window. One area of interest is control systems for driving optical transitions in optically switchable windows to provide requested lighting conditions, e.g., while reducing the power consumption of such devices and/or improving the efficiency of systems with which they are integrated.

### SUMMARY

Various aspects disclosed herein alleviate as least part of the shortcomings and/or materialize at least part of the aspirations related to digital collaboration of participants located remotely from one another.

Various embodiments herein relate to methods, systems, software and networks for providing an immersive experience, which simulates common presence of a virtual participant(s) and/or related virtual auxiliary content, and present (e.g., local) participant(s) in conference (e.g., enabled by video conferencing). Such simulation may include (i) using an at least partially transparent media display having a portion of its projecting entities (e.g., pixels) projecting the virtual participant's image and/or (e.g., select) virtual auxiliary content, while keeping at least a portion of the background at least partially transparent (e.g., to visible light), (ii) optionally disposing optical sensor(s) (e.g., included in a camera) behind the transparent media display at the gaze of the participant, and (iii) optionally using added virtual overlays (e.g., plants, furniture) to the virtual image that are consistent with the local environment, which virtual overlays appear perspectively close to the local participants, e.g., to provide a sense of depth ranging from the overlays to the virtual participant projection and/or to the background showing through the transparent media display. Placement of the optical sensor(s) (e.g., camera) behind and at the gaze of the real participant, may allow the participant to view the virtual participant while simultaneously being photographed at the real (e.g., actual) participant's gaze (e.g., focal point). The transparent media display can include touchscreen functionality, e.g., for shared access to any auxiliary documents (e.g., a virtual whiteboard), e.g., making it seem as if the users are sharing the same physical document in real time.

In another aspect, a method for digital collaboration, the method comprises: (A) establishing a communication link between (i) a first processor operatively coupled to a first media display and associated sensor disposed at a first location occupied by at least one first user and (ii) a second processor operatively coupled to a second media display disposed at a second location occupied by at least one second user; and (B) displaying, with the first media display at the first location, a media stream from the second processor communicated to the first media display via the communication link, wherein a portion of the media stream is suppressed from being displayed on the first media display that is at least partially transparent to visible light, which suppression enables viewing at least a portion of the first location through a portion of the first media display corresponding to the media stream that is suppressed.

In some embodiments, the second processor is operatively coupled to an other sensor configured to capture to at least one second user in the second location. In some embodiments, the communication link comprises a machine to machine communication. In some embodiments, the portion of the media stream which is suppressed comprises a region around an other portion of the media stream which depicts the second user. In some embodiments, the first media display comprises a transparent display, and wherein the portion of the media stream which is suppressed facilitates at least partial viewing of the first location of the first user through the transparent display. In some embodiments, the transparent display facilitates transmission of at least about 30% of light in the visible spectrum therethrough. In some embodiments, the transparent display facilitates transmission of from about 20% to about 90% of light in the visible spectrum therethrough. In some embodiments, the first media display is coupled to a tintable window. In some embodiments, the tintable window alters visibility, color, transmission, and/or reflectance of visible light. In some embodiments, the tintable window comprises an electrochromic device. In some embodiments, the electrochromic device is included in an insulated glass unit configured for installation in an enclosure. In some embodiments, the transparent display spans at least about 30% of an area of the tintable window. In some embodiments, the transparent display spans from about 10% to about 100% of an area of the tintable window. In some embodiments, the tintable window is coupled to a control system configured for adjusting a tint of the tintable window. In some embodiments, the control system comprises, or is operatively coupled to, a building management system. In some embodiments, the control system comprises a distributed network of controllers. In some embodiments, the control system comprises a hierarchical control system in which a master controller is configured to control one or more local controllers. In some embodiments, the control system comprises a controller that is included in a device ensemble, wherein the device ensemble is disposed in an enclosure. In some embodiments, the device ensemble comprises (i) sensors or (ii) a sensor and an emitter. In some embodiments, the device ensemble is disposed in a fixture (e.g., framing portion, ceiling, or wall). In some embodiments, the device ensemble is disposed in a non-fixture (e.g., a furniture, a billboard, or another tangible and movable asset). In some embodiments, the device ensemble comprises (i) a plurality of processors or (ii) a plurality of circuit boards. In some embodiments, the method further comprises (C) displaying on the first media display at least one virtual object which depicts a furnishing that spatially appears to be disposed between (i) the first user and (ii) the media stream displayed on the first media display. In some embodiments, the at least one virtual object is displayed so that it provides an apparent depth which is in front of an apparent depth of the depiction of the second user. In some embodiments, the at least one virtual object is configured to flank a depiction of the at least one second user at least during a portion of streaming the media stream of the at least one second user. In some embodiments, the sensor is an image sensor associated with the first media display, which sensor is configured to capture a first user of the at least one first user, for generating an other media stream to be communicated via the communication link to the second media display, which other media stream is associated with the first location, which first user gazes towards the first media display. In some embodiments, the method further comprises adjusting the capture location to focus on a central, or on a substantially central, position (i) between pupils of a first user of the at least one first user, (ii) between brows of the first user, and/or (iii) at the end of a nose bride of the first user. In some embodiments, the position is vertically aligned, horizontally aligned, or both vertically and horizontally aligned. In some embodiments, adjustment of the capture location is performed manually at least in part. In some embodiments, adjustment of the capture location is performed automatically. In some embodiments, adjustment of the capture location is based at least in part on image processing, machine learning, and/or artificial intelligence. In some embodiments, adjustment of the capture location is controlled by at least one controller. In some embodiments, adjustment of the capture location is controlled by a control system configured to control at least one other device of a facility in which the first media display is disposed. In some embodiments, the method further comprises using the sensor for generating the other media stream from a capture location which corresponds to a gazing region of the first user directed towards the first media display. In some embodiments, the sensor is movable with respect to the first media display, the method further comprising adjusting the capture location to match the gazing region of the first user. In some embodiments, adjustment of the capture location is performed manually at least in part. In some embodiments, adjustment of the capture location is performed automatically according to a captured image of the first user. In some embodiments, the first user is disposed on a first side of the media display, and wherein the capture location of the sensor is disposed on a second side of the first media display that is at least partially transparent to visible light, such that the media stream depicts the first user using images passing through the transparent display of the first media display, which first side is an opposite of the first media display relative to the second side. In some embodiments, the first media display that is at least transparent to visible light is configured to allow at least a portion of the visible light to pass therethrough. In some embodiments, the first media display is configured to allow visible light to pass therethrough when the first media display is nonoperational and/or when the first media display is operational. In some embodiments, the sensor is mounted on a movable carriage driven by the at least one controller. In some embodiments, the first media display is coupled to a tintable window. In some embodiments, the tintable window is an integrated glass unit, and wherein the movable carriage is (i) configured for planar motion, and (ii) disposed in an interior of the integrated glass unit. In some embodiments, the first media display includes a transparent substrate integrating a plurality of light emitting pixels, and wherein the sensor comprises a plurality of sensels disposed on the transparent substrate. In some embodiments, comprising displaying on the first media display and/or the second media display a shared auxiliary content at a region of the first media display and/or at a region of the second media display. In some embodiments, (i) the region of the first media excludes depictions of the at least one second user and/or (ii) the region of the second media excludes depictions of the at least one second user. In some embodiments, the shared auxiliary content is updatable by the at least one first user, by the at least one second user, or by both the at least one first user and the at least one second user. In some embodiments, the region displaying the shared auxiliary content is configured to facilitate touchscreen capability for modifying the shared auxiliary content. In some embodiments, the shared auxiliary content is digitally stored in storage which is responsive to the at least one first user and/or to the at least one second user via an auxiliary communication link. In some embodiments, at least one of the first media display and the second media display, is disposed in an individual portal laid out within an enclosure. In some embodiments, at least one of the first media display and the second media display, is disposed in a small group pod laid out within an enclosure. In some embodiments, at least one of the first media display and the second media display, is disposed in a large group zone laid out within an enclosure. In some embodiments, at least one of the first media display and the second media display, is disposed on a freestanding panel laid out within an enclosure. In some embodiments, at least one of the first media display and the second media display, is disposed in an activity hub laid out within an enclosure. In some embodiments, the method further comprises displaying, with the second media display at the second location, an other media stream of the at least the one first user sent to the second media display from the first media display via the communication link, wherein a first portion of the other media stream is suppressed from being displayed on the second media display that is at least partially transparent to visible light, to facilitate viewing of at least a portion of the second location through a portion of the second media display corresponding to the other media stream that is suppressed. In some embodiments, the other media stream of the at least one second user includes a video stream captured by an other sensor associated with the second media display, and wherein the other sensor captures the video stream from a second capture location which corresponds to a gazing region of a second user of the at least one second user, on the second media display.

In another aspect, an apparatus for digital collaboration, the apparatus comprises at least one controller configured to perform, or direct performance of, of any of the methods disclosed above.

In another aspect, an apparatus for digital collaboration, the apparatus comprises at least one controller configured to: (A) operatively couple to a first processor that is operatively coupled to a first media display disposed at a first location occupied by at least one first user, which operatively coupling of the first processor is via a communication link to a second processor that is operatively coupled to a second media display disposed at a second location occupied by at least one second user; and (B) direct the first media display to display a media stream of the at least one second user sent to the first processor from the second processor via the communication link, wherein a first portion of the media stream is suppressed from being displayed on the first media display that is at least partially transparent to visible light, which suppression enables viewing of at least a portion of the first location through a portion of the first media display corresponding to the media stream that is suppressed.

In some embodiments, the at least one controller comprises circuitry. In some embodiments, the first processor is included in a control system which comprises, or is operatively coupled to, a building management system. In some embodiments, the first processor is included in a control system which comprises a distributed network of controllers. In some embodiments, the first processor is included in a control system which comprises a hierarchical control system in which a master controller is configured to control one or more local controllers. In some embodiments, the first processor is included in a device ensemble, wherein the device ensemble is disposed in an enclosure. In some embodiments, the device ensemble comprises (i) sensors or (ii) a sensor and an emitter. In some embodiments, the device ensemble is disposed in a fixture (e.g., framing portion, ceiling, or wall). In some embodiments, the device ensemble is disposed in a non-fixture (e.g., a furniture, a billboard, or another tangible and movable asset),In some embodiments, the device ensemble comprises (i) a plurality of processors or (ii) a plurality of circuit boards. In some embodiments, the apparatus further comprises a tintable window which alters visibility, color, transmission, and/or reflectance of visible light, wherein the first processor is configured for adjusting a tint of the tintable window. In some embodiments, the apparatus further comprises the tintable window comprises an electrochromic device. In some embodiments, the apparatus further comprises the electrochromic device is included in an insulated glass unit configured for installation in an enclosure.

In another aspect, a non-transitory computer readable product instructions for digital collaboration, the non-transitory computer readable product instructions, when read by one or more processors, cause the one or more processors to execute, or direct execution, of any of the methods disclosed above.

In another aspect, a non-transitory computer readable product instructions for digital collaboration, the non-transitory computer readable product instructions, when read by one or more processors, cause the one or more processors to execute one or more operations, comprises: directing a first media display disposed at a first location, to display a media stream of the at least one second user disposed at a second location, which media stream is sent to a first processor operatively coupled to the first media display, from a second processor operatively coupled to the second media display, which media stream is sent via a communication link, wherein a first portion of the media stream is suppressed from the displaying on the first media display that is at least partially transparent to visible light, which suppression enables viewing of at least a portion of the first location through a portion of the first media display corresponding to the media stream that is suppressed, which one or more processors are operatively coupled to the first processor that is operatively coupled to the first media display disposed at the first location occupied by at least one first user, which operatively coupling of the first processor is via the communication link to the second processor operatively coupled to the second media display disposed at the second location occupied by the at least one second user.

In some embodiments, the product instructions are embedded in one of more non-transitory computer readable media. In some embodiments, the product instructions are included in a program product.

In another aspect, a system for digital collaboration, the system comprises a network configured to facilitate one or more operations of any of the methods disclosed above.

In some embodiments, facilitating one or more operations comprises operatively coupling to one or more devices, operatively coupling to one or more apparatuses, operatively coupling to one or more systems, facilitate communication and/or facilitate power transmission.

In another aspect, a system for digital collaboration, the system comprises: a network configured to: (a) operatively couple to a first media display disposed at a first location occupied by at least one first user, which first media display is operatively coupled to a first processor; a second media display disposed at a second location occupied by at least one second user, which second media display is operatively coupled to a second processor; and (b) facilitate a communication link between the first processor and the second processor, which communication link is configured to transmit the media stream transmitted to the first media display, wherein a first portion of the media stream is suppressed from being displayed on the first media display that is at least partially transparent to visible light, which suppression enables viewing of at least a portion of the first location through a portion of the first media display corresponding to the media stream that is suppressed.

In some embodiments, the network is configured for transmission of the media stream at least in part by being configured to enable transmission of a protocol of the media stream. In some embodiments, the network is operatively coupled to a hierarchical control system at least partially disposed in an enclosure which includes the first location. In some embodiments, the network is at least partly disposed in a facility and is capable of transmitting power and communication signals. In some embodiments, the network is configured to connect to a plurality of devices in the facility. In some embodiments, (i) at least two of the plurality of devices are of different type and/or (ii) at least two of the plurality of devices are of the same type. In some embodiments, the plurality of devices includes processors, controllers, sensors, emitters, receivers, transmitters, and/or device ensembles. In some embodiments, the plurality of devices includes a controller operatively coupled to a tintable window for operatively controlling the tintable window. In some embodiments, the plurality of devices includes a controller operatively coupled to control a lighting device, a tintable window, a sensor, an emitter, a media display, a dispenser, a processor, a power source, a security system, a fire alarm system, a sound media, an antenna, a radar, a controller, a heater, a cooler, a vent, or a heating ventilation and air conditioning system (HVAC). In some embodiments, the communication signals include cellular communication signals. In some embodiments, the network is configured to transmit at least fourth (4G) or at least fifth (5G) generation cellular communication. In some embodiments, the network is configured for transmission of power and communication signals using coaxial cables, optical wires, and/or twisted wires. In some embodiments, the network is configured of transmitting power and communication signals on a single cable. In some embodiments, the network is the first network installed in a facility. In some embodiments, the network is disposed at least in an envelope of a facility. In some embodiments, the network is configured to transmit two or more communication types on a single wire. In some embodiments, the communication types comprise cellular communication, video communication, control communication, or other data stream.

In another aspect, a method for digital collaboration, the method comprising using a sensor to capture a media stream of at least the one first user disposed in a first location, which sensor is associated with a first media display disposed in the first location, and is configured to obtain the media stream of at least one first user through the first media display that is at least partially transparent to visible light.

In some embodiments, the method further comprises establishing a communication link between (i) a first processor operatively coupled to the first media display and (ii) a second processor operatively coupled to a second media display disposed at a second location occupied by at least one second user. In some embodiments, the communication link comprises a machine to machine communication. In some embodiments, the communication link is configured to facilitate transmission of the media stream. In some embodiments, the method further comprises transmitting the media stream for display on the second media display. In some embodiments, the method further comprises using the sensor for generating the media stream from a capture location which corresponds to a gazing region of the first user directed towards the first media display. In some embodiments, the method further comprises adjusting the capture location to focus on a central, or on a substantially central, position (i) between pupils of a first user of the at least one first user, (ii) between brows of the first user, and/or (iii) at the end of a nose bride of the first user. In some embodiments, the position is vertically aligned, horizontally aligned, or both vertically and horizontally aligned. In some embodiments, adjustment of the capture location is performed manually at least in part. In some embodiments, adjustment of the capture location is performed automatically. In some embodiments, adjustment of the capture location is based at least in part on image processing, machine learning, and/or artificial intelligence. In some embodiments, adjustment of the capture location is controlled by at least one controller. In some embodiments, adjustment of the capture location is controlled by a control system configured to control at least one other device of a facility in which the first media display is disposed. In some embodiments, the sensor is movable with respect to the first media display, the method further comprising adjusting the capture location to match the gazing region of the first user. In some embodiments, the adjusting of the capture location is performed manually at least in part. In some embodiments, adjustment of the capture location is performed automatically according to a captured image of the first user. In some embodiments, the first user is disposed on a first side of the media display, and wherein the capture location of the sensor is disposed on a second side the first media display that is at least partially transparent to visible light, such that the first media stream depicts the first user using images passing through the transparent display of the first media display, which first side is an opposite of the first media display relative to the second side. In some embodiments, the sensor is mounted on a movable carriage driven by at least one controller. In some embodiments, the first media display is coupled to a tintable window. In some embodiments, the tintable window is an integrated glass unit, and wherein the movable carriage is (i) configured for planar motion, and (ii) disposed in an interior of the integrated glass unit. In some embodiments, the first media display includes a transparent substrate integrating a plurality of light emitting pixels, and wherein the sensor comprises a plurality of sensels disposed on the transparent substrate. In some embodiments, the first media display is coupled to a tintable window. In some embodiments, the tintable window alters visibility, color, hue, transmission, and/or reflectance of visible light. In some embodiments, the tintable window comprises an electrochromic device. In some embodiments, the electrochromic device is included in an insulated glass unit configured for installation in an enclosure. In some embodiments, the transparent display spans at least about 30% of an area of the tintable window. In some embodiments, the transparent display spans from about 10% to about 100% of an area of the tintable window. In some embodiments, the tintable window is coupled to a control system configured for adjusting a tint of the tintable window. In some embodiments, the control system comprises, or is operatively coupled to, a building management system. In some embodiments, the control system comprises a distributed network of controllers. In some embodiments, the control system comprises a hierarchical control system in which a master controller that is configured to control one or more local controllers. In some embodiments, the control system comprises a controller that is included in a device ensemble, wherein the device ensemble is disposed in the enclosure. In some embodiments, the device ensemble comprises (i) sensors or (ii) a sensor and an emitter. In some embodiments, the device ensemble is disposed in a fixture (e.g., framing portion, ceiling, or wall). In some embodiments, the device ensemble is disposed in a non-fixture (e.g., a furniture, a billboard, or another tangible and movable asset). In some embodiments, the device ensemble comprises (i) a plurality of processors or (ii) a plurality of circuit boards. In some embodiments, at least one of the first media display and the second media display, is disposed in an individual portal laid out within an enclosure. In some embodiments, at least one of the first media display and the second media display, is disposed in a small group pod laid out within an enclosure. In some embodiments, at least one of the first media display and the second media display, is disposed in a large group zone laid out within an enclosure. In some embodiments, at least one of the first media display and the second media display, is disposed on a freestanding panel laid out within an enclosure. In some embodiments, at least one of the first media display and the second media display, is disposed in an activity hub laid out within an enclosure.

In another aspect, an apparatus for digital collaboration, the apparatus comprises at least one controller configured to perform, or direct performance of, of any of the methods disclosed above.

In another aspect, an apparatus for digital collaboration, the apparatus comprises at least one controller configured to: (A) operatively couple to a sensor that is (i) configured for capturing a media stream (ii) associated with a first image display, (iii) is disposed in a first location in which the first image display is disposed, and (iv) configured to obtain the media stream through the first media display that is at least partially transparent to visible light; and (B) direct the sensor to capture the media stream in the first location.

In some embodiments, the first media display is operatively coupled to a first processor, which first location is occupied by at least one first user, which first processor is operatively coupled via a communication link to a second processor operatively coupled to a second media display disposed at a second location occupied by at least one second user. In some embodiments, the at least one controller is configure to direct transmission of the media stream for display by the second media display.

In another aspect, a non-transitory computer readable product instructions for digital collaboration, the non-transitory computer readable product instructions, when read by one or more processors, causes the one or more processors to execute, or direct execution, of any of the methods disclosed above.

In another aspect, a non-transitory computer readable product instructions for digital collaboration, the non-transitory computer readable product instructions, when read by one or more processors, causes the one or more processors to execute one or more operations comprises: directing a sensor to capture a media stream in a first location, which one or more processors are operatively coupled to the sensor that is (i) configured for capturing a media stream (ii) associated with a first image display, (iii) is disposed in a first location in which the first image display is disposed, and (iv) configured to obtain the media stream through the first media display that is at least partially transparent to visible light.

In some embodiments, the product instructions are embedded in one of more non-transitory computer readable media. In some embodiments, the product instructions are included in a program product.

In another aspect, a system for digital collaboration, the system comprises a network configured to facilitate one or more operations of any of the methods disclosed above.

In some embodiments, facilitating one or more operations comprises operatively coupling to one or more devices, operatively coupling to one or more apparatuses, operatively coupling to one or more systems, facilitate communication and/or facilitate power transmission.

In another aspect, a system for digital collaboration, the system comprises: a network configured to: (a) operatively coupling to a sensor that is (i) configured for capturing a media stream (ii) associated with a first image display, (iii) is disposed in a first location in which the first image display is disposed, and (iv) configured to obtain the media stream through the first media display that is at least partially transparent to visible light; and (b) facilitate a communicating of the media stream.

In some embodiments, the network is configured for transmitting the media stream at least in part by being configured to enable transmission of a protocol of the media stream. In some embodiments, the network is configured to operatively coupled to a hierarchical control system at least partially disposed in an enclosure which includes the first location. In some embodiments, the network is at least partly disposed in a facility and is capable of transmitting power and communication signals. In some embodiments, the network interconnects a plurality of devices in the facility. In some embodiments, the plurality of devices includes processors, controllers, sensors, emitters, receivers, transmitters, and/or device ensembles. In some embodiments, the plurality of devices includes a controller operatively coupled to a tintable window for operatively controlling the tintable window. In some embodiments, the plurality of devices includes a controller operatively coupled to control a lighting device, a tintable window, a sensor, an emitter, a media display, a dispenser, a processor, a power source, a security system, a fire alarm system, a sound media, an antenna, a radar, a controller, a heater, a cooler, a vent, or a heating ventilation and air conditioning system (HVAC). In some embodiments, the communication signals include cellular communication signals. In some embodiments, the network is configured to transmit at least fourth (4G) or at least fifth (5G) generation cellular communication. In some embodiments, the network is configured for transmission of power and communication signals using coaxial cables, optical wires, and/or twisted wires. In some embodiments, the network is capable of transmitting both power and communication signals in a single cable. In some embodiments, the network is the first network installed in a facility. In some embodiments, the network is disposed at least in an envelope of a facility. In some embodiments, the network is configured to transmit two or more communication types on a single wire. In some embodiments, the communication types comprise cellular communication, video communication, control communication, or other data stream.

In some embodiments, operatively coupled comprises physically coupled, wirelessly coupled, communicatively coupled, or electronically coupled.

In another aspect, the present disclosure provides systems, apparatuses (e.g., controllers), and/or non-transitory computer-readable medium (e.g., software) that implement any of the methods disclosed herein.

In another aspect, the present disclosure provides methods that use any of the systems and/or apparatuses disclosed herein, e.g., for their intended purpose.

In another aspect, an apparatus comprises at least one controller that is programmed to direct a mechanism used to implement (e.g., effectuate) any of the method disclosed herein, wherein the at least one controller is operatively coupled to the mechanism.

In another aspect, an apparatus comprises at least one controller that is configured (e.g., programmed) to implement (e.g., effectuate) the method disclosed herein. The at least one controller may implement any of the methods disclosed herein.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may direct any apparatus (or component thereof) disclosed herein.

In another aspect, a computer software product, comprising a non-transitory computer-readable medium in which program instructions are stored, which instructions, when read by a computer, cause the computer to direct a mechanism disclosed herein to implement (e.g., effectuate) any of the method disclosed herein, wherein the non-transitory computer-readable medium is operatively coupled to the mechanism. The mechanism can comprise any apparatus (or any component thereof) disclosed herein.

In another aspect, the present disclosure provides a non-transitory computer-readable medium comprising machine-executable code that, upon execution by one or more computer processors, implements any of the methods disclosed herein.

In another aspect, the present disclosure provides a non-transitory computer-readable medium comprising machine-executable code that, upon execution by one or more computer processors, effectuates directions of the controller(s) (e.g., as disclosed herein).

In another aspect, the present disclosure provides a computer system comprising one or more computer processors and a non-transitory computer-readable medium coupled thereto. The non-transitory computer-readable medium comprises machine-executable code that, upon execution by the one or more computer processors, implements any of the methods disclosed herein and/or effectuates directions of the controller(s) disclosed herein.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 depicts an immersive video interaction between collaborators via a media display;

FIG. 2 schematically shows a side view of an arrangement of a media display and movable sensor(s) (e.g., camera);

FIG. 3 shows a plan view of a display and movable sensor(s) (e.g., camera);

FIG. 4 shows interactions of media display substrates with image sensors;

FIG. 5 schematically illustrates a user cutout to be extracted from an incoming image to be displayed on a media display;

FIG. 6 depicts an immersive video interaction between collaborators via a transparent media display integrated with an exterior window of a building;

FIG. 7 depicts an immersive video interaction between collaborators via a transparent media display on a standalone panel inside a facility;

FIG. 8 shows a flowchart of an immersive collaboration method;

FIG. 9 depicts an enclosure communicatively coupled to its digital twin representation;

FIGS. 10A and 10B show various windows and displays;

FIG. 11 schematically shows a display (e.g., a display construct assembly);

FIG. 12 schematically shows a user interacting with a device of disposed on or attached to a wall;

FIG. 13 schematically shows a perspective view of an office space in a building including areas for immersive video collaboration;

FIG. 14 depicts an immersive video interaction between collaborators using an individual portal;

FIG. 15 depicts a nook or pod for immersive video interaction which is at least partially enclosed for privacy;

FIG. 16 depicts an immersive video interaction between collaborators using multiple individual portals;

FIG. 17 depicts an immersive video interaction between collaborators using multiple displays in a local area accommodating many local participants;

FIG. 18 schematically shows an electrochromic device;

FIG. 19 shows a cross-sectional view of an example electrochromic window in an Integrated Glass Unit (IGU);

FIG. 20 schematically shows an example of a control system architecture and a building;

FIG. 21 shows a schematic example of a sensor arrangement;

FIG. 22 schematically shows a processing system and related components; and

FIG. 23 show various windows and a display construct in a framing system.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling. The non-physical coupling may comprise signal-induced coupling (e.g., wireless coupling). Coupled can include physical coupling (e.g., physically connected), or non-physical coupling (e.g., via wireless communication). Additionally, in the following description, the phrases “operable to,” “adapted to,” “configured to,” “designed to,” “programmed to,” or “capable of” may be used interchangeably where appropriate.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

The following detailed description is directed to specific example implementations for purposes of disclosing the subject matter. Although the disclosed implementations are described in sufficient detail to enable those of ordinary skill in the art to practice the disclosed subject matter, this disclosure is not limited to particular features of the specific example implementations described herein. On the contrary, the concepts and teachings disclosed herein can be implemented and applied in a multitude of different forms and ways without departing from their spirit and scope. For example, while the disclosed implementations focus on electrochromic windows (also referred to as smart windows), some of the systems, devices and methods disclosed herein can be made, applied or used without undue experimentation to incorporate, or while incorporating, other types of optically switchable devices that are actively switched/controlled, rather than passive coatings such as thermochromic coatings or photochromic coatings that tint passively in response to the sun's rays. Some other types of actively controlled optically switchable devices include liquid crystal devices, suspended particle devices, and micro-blinds, among others. For example, some or all of such other optically switchable devices can be powered, driven or otherwise controlled or integrated with one or more of the disclosed implementations of controllers described herein.

In some embodiments, an enclosure comprises an area defined by at least one structure (e.g., fixture). The at least one structure may comprise at least one wall. An enclosure may comprise and/or enclose one or more sub-enclosure. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame and/or wooden frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure at most about 30%, 20%, 10%, 5%, or 1% of the walls(s). The wall(s) may comprise a floor, a ceiling, or a side wall. The closable opening may be closed by at least one window or door. The enclosure may be at least a portion of a facility. The facility may comprise a building. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, facade, mezzanine, penthouse, garage, porch (e.g., enclosed porch), terrace (e.g., enclosed terrace), cafeteria, and/or Duct. In some embodiments, an enclosure may be stationary and/or movable (e.g., a train, an airplane, a ship, a vehicle, or a rocket).

In some embodiments, the enclosure encloses an atmosphere. The atmosphere may comprise one or more gases. The gases may include inert gases (e.g., comprising argon or nitrogen) and/or non-inert gases (e.g., comprising oxygen or carbon dioxide). The enclosure atmosphere may resemble an atmosphere external to the enclosure (e.g., ambient atmosphere) in at least one external atmosphere characteristic that includes: temperature, relative gas content, gas type (e.g., humidity, and/or oxygen level), debris (e.g., dust and/or pollen), and/or gas velocity. The enclosure atmosphere may be different from the atmosphere external to the enclosure in at least one external atmosphere characteristic that includes: temperature, relative gas content, gas type (e.g., humidity, and/or oxygen level), debris (e.g., dust and/or pollen), and/or gas velocity. For example, the enclosure atmosphere may be less humid (e.g., drier) than the external (e.g., ambient) atmosphere. For example, the enclosure atmosphere may contain the same (e.g., or a substantially similar) oxygen-to-nitrogen ratio as the atmosphere external to the enclosure. The velocity and/or content of the gas in the enclosure may be (e.g., substantially) similar throughout the enclosure. The velocity and/or content of the gas in the enclosure may be different in different portions of the enclosure (e.g., by flowing gas through to a vent that is coupled with the enclosure). The gas content may comprise relative gas ratio.

In some embodiments, a transparent media display is supported on a transparent panel or substrate having a planar shape. The transparent panel may include a glass pane, a plastic sheet, or other clear material for supporting a media display, and may be configured as a window having a transparent display area. The transparent panel and/or transparent media display may be configured as a thin sheet which follows a straight, curved shape and/or may include bends or other contours. The media display may provide unidirectional projection of images from one side of the media display toward its opposing side to a local user. The unidirectional projection may maintain privacy of the projected media and/or reduce eye strain for the user viewing the projected media by the display.

The projecting media display (e.g., display matrix) may comprise a light emitting diode (LED) array. The LED array may comprise an organic material (e.g., organic light emitting diode abbreviated herein as “OLED”). The OLED may comprise a transparent organic light emitting diode display (abbreviated herein as “TOLED”), which TOLED is at least partially transparent (e.g., to visible light). The display construct may comprise the media display, binding material, and/or transparent substrates (e.g., glass) to bind it together to a display construct. The display construct my comprise a high resolution display. In some embodiments, the display matrix has at least about 2000 pixels at its fundamental length scale, which pixels are the projecting entities of the media display. In some embodiments, the fundamental length scale (abbreviated as “FLS”) of the display matrix is a height or a width of the display matrix. In some embodiments, the display matrix is a high resolution or an ultra-high resolution display matrix. In some embodiments, the display construct is configured as a free-standing panel within an enclosure for generating a media display output toward a user on one side of the free-standing panel.

In some embodiments, the display construct is coupled to a viewing (e.g., tintable) window such as by a fastener, wherein the window defines a portion of an exterior or interior wall. In some embodiments, the fastener comprises a hinge, a bracket, or a cover. In some embodiments, the hinge is (i) connected to the bracket that is connected to the display construct and (ii) connected to the cover that is connected to a fixture, which hinge facilitates swiveling of the display construct with respect to the fixture about a hinge joint. In some embodiments, the hinge is (i) reversibly connected to the bracket that is irreversibly connected to the display construct and (ii) reversibly connected to the cover that is reversibly connected to a fixture, which hinge facilitates swiveling of the display construct with respect to the fixture about a hinge joint. In some embodiments, the cover comprises a swiveling portion that can be reversibly opened and closed. In some embodiments, a circuitry and/or wiring is covered from a viewer by the cover, which circuitry and/or wiring can be exposed at least in part by opening the swiveling portion.

In some embodiments, when the tintable window is in its darkest tint state and the display construct projects the media, a user cannot see through (i) the display construct and (ii) the tintable window. In some embodiments, a tint level of the tintable window considers a position of a sun, weather condition, transmittance of light through the tintable windows, media projected by the display, and/or reading of one or more sensors. In some embodiments, at least one of the one or more sensors is disposed externally to the building in which the tintable window is disposed. In some embodiments, the weather condition comprises any dispersive entities in the atmosphere (e.g., cloud coverage, dust, rain, hail, or snow). In some embodiments, transmittance of light through the tintable windows is with respect to external light impinging on the viewing (e.g., tintable) window. In some embodiments, the transmittance of light through the viewing (e.g., tintable) window depends on the material properties of the viewing (e.g., tintable) window. The material properties may include manner of fabrication, thickness of one or more layers, conductive entity type, conductive entity concentration, and/or FLS, of the tintable window (e.g., optically switchable device included therein, such as an electrochromic construct).

With the media display being transparent at least in part and being disposed on a transparent support panel, a visual reproduction of a remote user on the media display may be presented in a way that results in an enhanced immersive experience. In some embodiments, video reproduction of the remote user is generated on a portion of the media display (e.g., as a cutout or filled-in silhouette of the remote user) while another portion of the media display is 1) muted (e.g., remains transparent so that the local user see through the media display to a local environment on the opposite side of the media display), and/or 2) reproduces virtual objects devised to enhance an illusion that the remote user is integrated with the local environment. As used herein, the term “media display” or media display construct” may include light emitting structures and light receiving structures, as well as supporting electronics such as an image processor, controller, and network interfaces capable of generating, transmitting, receiving, and or manipulating video streams.

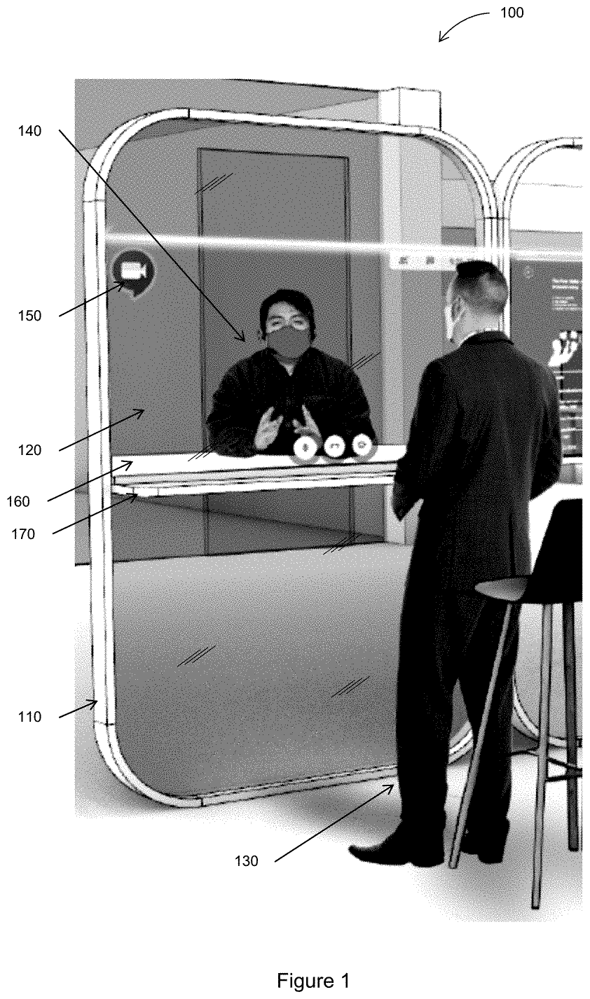

FIG. 1 shows an example of digital collaboration unit 100 that is a standalone unit. A transparent panel carries a media display 120 over at least a part of the surface of the panel bordered by framing 110. For example, display 120 may occupy an area on the panel bordered by framing 110, with an aspect ratio corresponding to a video output generated by conventional image sensors (e.g., an aspect ratio of about 16:9, of about 4:3, or any value between the aforementioned aspect ratios). The panel bordered by framing 110 and display 120 are free-standing in an enclosure such as an office space, e.g., for utilization by a local user 130 disposed on a side of media display 120 toward which video images are projected by display 120. User 130 is engaged in a video conference with a remote user who is depicted by a streamed virtual image 140 on the display 120, wherein the media stream used to generate image 140 may be captured by an image sensor at the remote location of the remote user. The image taken by the remote image sensor may be trimmed to project an image of the remote user, e.g., without any projected content in at least in a portion of the area surrounding the remote user (e.g., in the manner of a green-screen cutout) to provide an illusion that the remote user is seen as being present in the local environment. The example shown in FIG. 1 shows a remote user 140 that is cut from its real surrounding captured by the remote sensor, which remote surrounding appear transparent to user 130, such that user 130 can see cutout image 140 of the remote user devoid of the remote surrounding, and user 130 can see through a surrounding of cutout image 140. The display may generate the remote user's image at an image scale that causes the size of the image to represent the remote user at or close to life-size, e.g., with respect to the local user 130. The removal of a remote surrounding (e.g., background around the remote user's virtual image) can be performed locally in an image processor coupled to media display 120, remotely on the media stream before being transmitted. Remotely may be in a cloud, at the remote user's local, or at any other remote place to user 130. In some embodiments, media display 120 has a touchscreen capability (not shown in FIG. 1). The locally displayed images includes icons 150, e.g., that may be used for a control interface allowing user 130 to generate user commands for a control system handling the video conference. Although not shown, a digital collaboration unit (e.g., the media display and associated controller and/or processor) may include microphone(s) and/or other sound sensor(s), loudspeaker(s), etc., e.g., to facilitate audio communication. FIG. 1 shows an example of a real ledge on which user 130 can lean and/or place real items on, and virtual ledge 160 that remote user 140 seems to lean on. The virtual ledge 160 may be a real remote ledge captured by the remote camera, or an emulated perspective ledge that is a virtual overlay. The panel held by framing 110 can comprise a transparent substrate (e.g., glass or plastic), which transparent substrate may comprise a tintable window. The transparent substrate may support the display construct 120. The display construct may be supported by ramming 110 (e.g., an unsupported by the transparent substrate that is surrounded by framing 110).

In some embodiments, an immersive experience is enhanced by locating at least one sensor (e.g., an optical sensor such as an image sensor) behind at least a portion of the transparent media display to capture images of a user (e.g., video conference participant) from a location corresponding to the user's gaze, e.g., while participating in the video conference. To provide an appearance of a local user (e.g., as seen by the other remote user(s) on the video conference) in which the local user seems to be looking directly at the other remote user(s) (e.g., instead of appearing to be looking off to one side as with conventional image sensors located off to the side of a display such as a computer monitor), the sensor(s) may be positioned behind the transparent display. In some embodiments, the image sensor location is arranged to be directly behind a position on the media display from which the remote user's image is projected to the local user. As a result, the local user's focal point, when looking at the image of a remote participant, becomes aligned with the sensor(s) (e.g., camera) placement, and the media stream sent to the remote participant(s) represents that focal point as being pointed directly toward the remote participant. Since the media display is transparent at least in part (e.g., passes some degree of visible light in both directions), an image of the local user may be captured from an opposite side of the media display and/or support panel (e.g., within the aspect-ratio profile of the media display). In some embodiments, the image sensor(s) (e.g., sensor array) is disposed at a fixed location (e.g., at a vertical and horizontal center) relative to the media display. In some embodiments, the image sensor location is adjustable (manually and/or automatically) in a vertical direction and/or a horizontal direction, e.g., to correspond with an actual gazing direction of the user whose images are being captured (e.g., the local user).

In some embodiments, at least one sensor is disposed behind the display, e.g., to capture an image of a local user (e.g., to be streamed to remote user(s)). For placing a sensor(s) (e.g., video camera or other image sensor(s)) behind a transparent display to capture images of a local user, a separate sensor(s) (e.g., optical sensor and/or image sensor) may be deployed behind the display construct, or an integrated sensor(s) may be disposed within (or intimately associated with) the display construct. Behind the media display, is a side of the media display that is opposite to the side in which the user is disposed and/or towards which the image is projected by the media display (e.g., in a unidirectionally projecting media display). In some embodiments, a sensor(s) (e.g., video image sensor and/or sensor array) is configured as an autonomous unit supported on an opposite side of the transparent panel, which opposite side of the media display is a side of the media display that is (i) opposite to the side in which a local user is disposed and/or (ii) towards which the image is projected by the media display (e.g., in a unidirectionally projecting media display). Placing the sensor(s) behind the displayed image by the media display, can help obscure the sensor(s) from the local user's view. The media display can be a display construct that is part of an integrated glass unit (IGU). The media display can be coupled (e.g., attached via an adhesive and/or a fastener) to the supportive structure (e.g., tintable window). The supportive structure (e.g., tintable window) can be part of an IGU. In some embodiments, the sensor(s) (e.g., a camera) is integrated as part of the IGU (e.g., located between inner and outer glass panes in an IGU) and directed toward the user through a transparent display. The transparent display can be associated with the inner pane of an IGU, or externally coupled to an IGU that is devoid of a media display.

In some embodiments, the sensor(s) that capture an image in the local in which the display is disposed, are included in a camera. An optical focus (e.g., fixed focus) of the camera (e.g., which is disposed behind a transparent display) may be set to correspond to a nominal distance from the camera to a typical position of a local user (in the facility in which the camera is disposed). The focal distance may be different (e.g., significantly greater) than the distance from the camera to the transparent display, e.g., such that any image artifacts related to any light projected by the display and/or any visible structures of the display, are muted by de-focusing. Image processing may be used to remove or otherwise compensate for any light that might be emitted by the media display toward the camera. The camera may have an adjustable focus. The adjustable focus may be manually and/or automatically adjusted. For example, the focal point of the camera may be adjusted, e.g., automatically and/or by a user (e.g., using an application (App.).

In some embodiments, the sensor(s) (e.g., in a camera) may be configured for height adjustment, e.g., to match an eye level of the person being captured. The sensor(s) may be operatively coupled (e.g., connected) to an actuator such as a motor (e.g., a servo-motor). The actuator may comprise a Servomechanism (e.g., abbreviated herein as “servo”). The actuator may use feedback control scheme to correct the action of the sensor(s). The actuator may be operatively coupled to one or more controllers (e.g., a dedicated controller and/or the control system of the facility). The feedback scheme may comprise error-sensing negative feedback. The actuator may control the displacement of the sensor(s). The actuator may comprise, or be operatively coupled to, an encoder. The actuator may be operatively coupled to a position feedback mechanism, e.g., to ensure the position of the sensor(s) is at the user's gaze, The sensor(s) may be operatively coupled to one or more controllers that include a feedback control scheme. The one or more controllers may receive error-correction signals to help control mechanical position of the sensor(s), speed of the sensor(s) movement, attitude or any other measurable variables related to displacement of the sensor(s). The feedback control scheme may comprise a dosed-loop feedback control scheme. The sensor(s) (e.g., camera) may be disposed on a support such as a carrier. The actuator may facilitate automatically positioning the sensor(s) (e.g., camera) to a center of the user's gaze (e.g., moving up-down and/or right-left). Down may be towards a gravitational center. The sensor(s) (e.g., camera) may be static or movable. The movement may be manually controlled by the local participant who is at the same local as the sensor(s) (e.g., in the same facility such as in the same room). In some embodiments, (e.g., manual) preferences for positioning an adjustable sensor(s) are stored, e.g., and assigned per user, per media display, and/or per local (e.g., per conference room and/or booth). The preferences may later be recalled, e.g., for automatically controlling the sensor position in response to activation of that sensor(s) (e.g., camera) by the user. The preferences may later be recalled, e.g., for automatically controlling sensor(s) position in response to activation of another sensor(s) (e.g., another camera) by the same user (e.g., the user preferences may be propagated to other media displays operatively coupled to vision sensor(s)). In some embodiments, movement is controlled to follow the optimal gaze point automatically, e.g., by using image recognition software. For example, facial feature tracking based at least in part on pattern recognition, can be optionally applied to the captured images. The facial feature may comprise eyes, pupils, nose (e.g., bridge and/or nostrils), eye brows, ears, distance between eyebrows, cheeks, chin, mouth, border of face, or hair line. The sensor(s) position adjustment may use a combination of techniques. For example, user preferences may be propagated to other media displays operatively coupled to vision sensor(s) as an initial sensors, and fine tuned (i) using image recognition software and/or (ii) manual user adjustment.

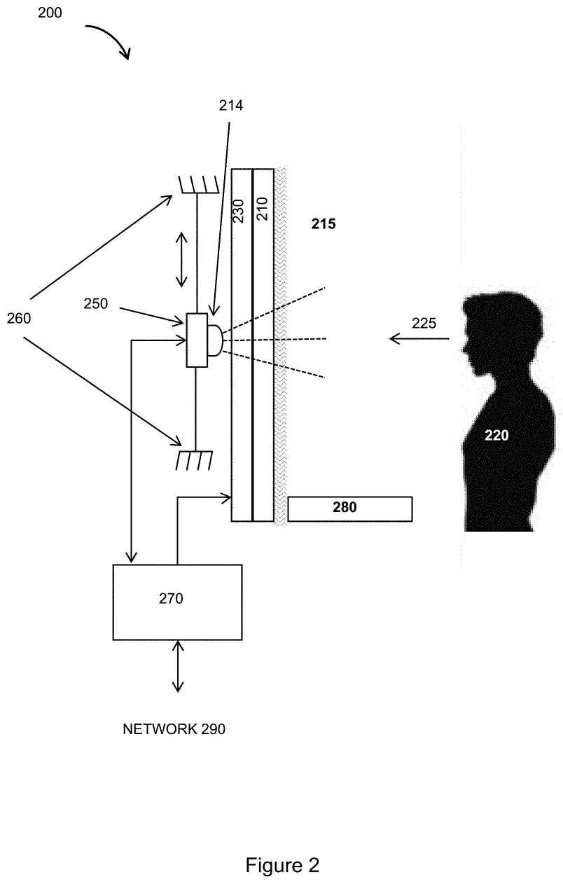

FIG. 2 shows an example of a camera system 200 for aligning a location from which images are captured with a focal point of a user's gaze toward the media display. A transparent media display 210 projects video images 215 toward a local user 220 who is disposed on a viewing side of media display 210. User 220 has a gazing direction 225 when looking at media display 210 when viewing a media stream, e.g., of a remote participant of a video conference and/or other digital collaboration. Media display 210 is supported by and/or is disposed on a transparent panel 230, which may be comprised of a tintable window. Sensor(s) 214 (e.g., in a camera) is disposed on a movable carriage (e.g., servo-system) 250 that is supported by mounts 260 fixed relative to panel 230 and media display 210. In some embodiments (not shown in the example of FIG. 2), the mount is integrated or attached to: the media display, the supportive substrate, and/or to a framing thereof. FIG. 2 shows an example of at least one controller 270 that is coupled to the movable carriage 250 for commanding movements of the carriage that place image sensor 214 in alignment with gazing direction 225. Controller 270 is operatively coupled to a network 290, e.g., for streaming content between local system 200 and the remote systems (e.g., media displays and controller) of the remote participant(s).

In some embodiments, the facility comprises a network. The network may be a communication and/or power network. The network may be coupled to a control system (e.g., that may comprise distributed network of controllers and/or a hierarchical control system). The display construct, the image sensor(s), and/or the tintable window may be operatively coupled to the network, e.g., and to the control system. The control system may control at least one other device of the facility such as devices adjusting to the environment of the facility, geo-location related devices, health, safety, entertainment, hospitality, work, and/or educational devices. At least a portion of the network may be (i) the first network deployed in the facility, (ii) disposed at an envelope of the facility, (iii) communicate power and communication on a single cable of the network, (iv) comprise electrical and optical cabling, (v) communicate two or more communication types on a single wire, and/or (vi) transmit communication and power on a single wire. The network may be configure to control different device types of the facility in which it is disposed. The network may be configured for environmental, health, and/or safety control. The local environment around local system 200 may include objects and/or surfaces perceived by user 220 during the collaboration. Some of the local environment may be seen through transparent media display 210 (e.g., portions not blocked by an image of the remote participants and/or auxiliary objects presented), and some objects are between user 220 and transparent media display 210. For example, a desk or table 280 may provide a work surface for user 220 at a lower end of media display 210. Virtual object(s) may be added to the images being displayed by media display 210 perspectively, e.g., to enhance an illusion that the remote participant(s) are in the local environment. For example, the virtual objects can include a virtual extension of table 280 that appears to local user 220 to perspectively extend into media display 210.

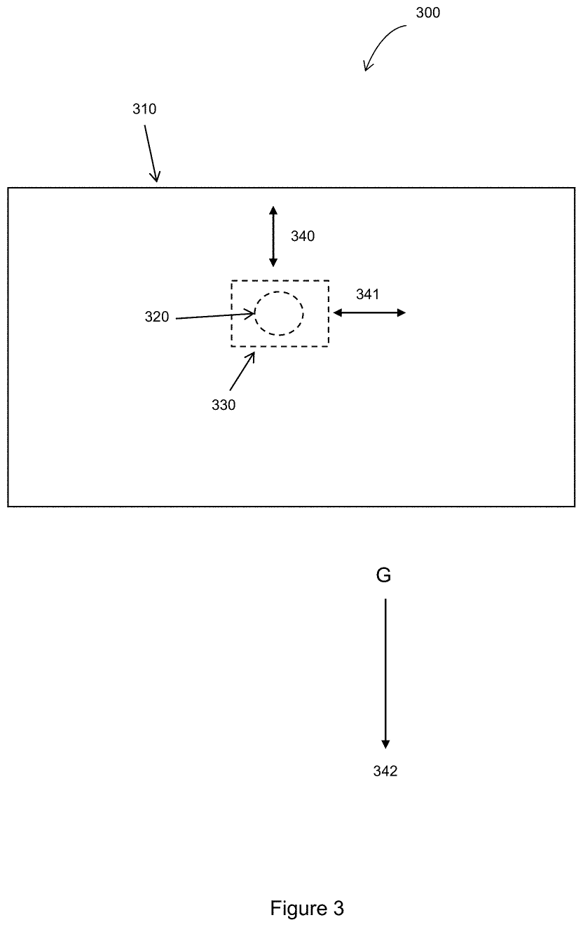

FIG. 3 shows an example of a front view of a digital collaboration system 300 having a transparent media display 310. Behind media display 310, image sensor(s) (e.g., in a camera) 320 is mounted on a movable carriage 330. Carriage 330 can be (e.g., servo and/or manually) controlled for vertical 340 and/or horizontal 431 movement with respect to gravitational center 342, e.g., to position sensor(s) 320 in a location corresponding to the local user's gaze.

In some embodiments, sensor(s) (e.g., comprising a video image sensor) is located separate from and/or behind a transparent media display, with behind being a side of the display away from the user and/or opposite to the direction of media projection by the display. A transparent display (such as a transparent organic light emitting diode (TOLED) array) can be configured to project an image substantially unidirectionally (e.g., from a front surface). At times, some portion of the light may be projected back toward the image sensor(s). The image sensor(s) may have an optical focal point such that a user located at a distance looking at the media display is in focus (e.g., at the focal point or substantially at the focal point), while the media display itself (e.g., the projecting entities of the media display) appears out of focus. The user may be disposed in front of the media display. The projecting entities of the media display may appear to the sensor(s) out of focus because (i) they are located away from the focal point of the sensor(s) (e.g., and closer to the sensor(s) as compared to the user). Any light leakage (e.g., glare) toward the sensor(s) from emitting entities of the media display (e.g., from the display pixels) may be spread over a plurality of sensors (e.g., sensing pixels) in the captured image, e.g., because of being out of focus. The emitting entities may include emitting entities that are within the field of view of the image sensor. The emitting entities may include emitting entities that are out of the field of view of the image sensor, e.g., and adjacent to the field of view of the image sensor. The brightness of any emitting entity (e.g., TOLED pixel) of the display as detected by any sensor (e.g., sensing pixel) may be (e.g., markedly) reduced (e.g., eliminated). The reduction may comprise filtering (e.g., optical filtering). The filtering may relate to the media projected by the projecting entities (e.g., that contribute to the glare). The reduction of glare may facilitate transmission of an image of a local user captured by the local sensor(s) through the transparent display, as transmitted to a remote user. The image captured by the local sensor(s) that is transmitted to the remote user(s), may by be crisp and/or minimally affected (e.g., unaffected) by projection of the local media display.

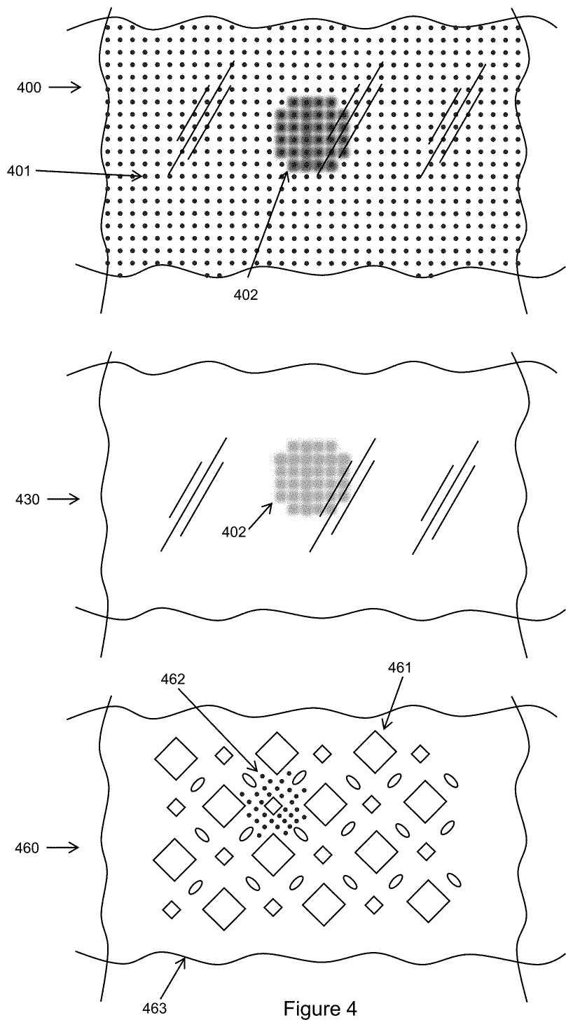

FIG. 4 depicts some example relationships between display pixels 401 and camera pixels. View 400 is a view from a front side of a media display wherein an array of LED pixels 401 project an image to a local user. The front side of the display is the side of the display observed by the user and/or towards which the media is displayed. A shaded area 402 corresponds to a region of the media display through which an image sensor behind the media display receives light being captured for a media stream to remote user(s). Thus, a subset of all the LED pixels of the media display are in a position to potentially project light in a backwards direction toward the image sensor. View 430 is a view from a rear side of the media display. Light directed from the rear side of the media display in region 402 appears diffused to the image sensor, e.g., since region 402 is de-focused. In some instances, each pixel of the camera image may capture an area within region 402 smaller than a pixel size of the media display. Without wishing to be bound to theory, this may be because of convergence of light rays directed onto the pixels of the image sensor. The de-focused light from a pixel of the media display can spread over a number of camera pixels, such that a captured image may be influenced (e.g., mostly defined) by the light of the exterior scene passing through the transparent media display.

In some embodiments, an integrated image sensor is disposed within, or is intimately associated with, the transparent display assembly. A transparent substrate or set of substrates joined together in a common construct may include light-emitting entities (e.g., pixels) for the media display and light-sensing camera pixels (also known as “sensels”) deposited on the common construct (e.g., as part of the media display construct). For example the sensels and the emitting entities of the media display can be part of a laminate or part of a common integrated glass unit (IGU). Various patterns can be employed for arranging the two pixel types to optimize imaging performance and/or minimize interactions between them. For (e.g., each) image pixel of the media display, light emitting entities may be provided for separate primary colors (e.g., RGB sub-pixels). The number of such elements, their surface areas, and/or arrangement patterns may depend upon an overall design and/or manufacturing process of the media display. The sensels may be arranged in a matrix (e.g., a grid of sensels). The projecting entities of the media display may be arranged in a matrix (e.g., a grid of projecting entities such as an LED grid). The grid of the sensels may be offset from the grid of projecting entities of the media display (e.g., to ensure optimal sensing of the sensels through the emitting entity matrix of the media display). The degree of offset between the two grids may facilitate minimum interference and/or overlap (e.g., no overlap, or substantially no overlap) between sensels and the projecting entities of the media display. Each of the light-emitting entities of the media display may occupy a larger surface area as compared to each of the light-sensing sensels. In some embodiments a sensei may have a size that is equal, or substantially equal, to a projecting entity of the media display (e.g., LED pixel). The light emitting entities may comprise TOLED pixels.

In some embodiments, sensels of a video image sensor array are disposed behind and/or between the media display pixels (e.g., in 2D from the user's perspective). A single lens, or a composite lens, may be incorporated (e.g., at least with respect to the imaging sensels), to capture the requested image. When integrated with a tintable window (e.g., an electrochromic window), the glass pane of the window can be patterned and/or controlled to provide an adjustable tint. The pattern and/or tint may function as an iris or filter for the senses (e.g., camera), e.g., embedded within the laminate and/or IGU.

To move the effective location (e.g., height) from which an image is captured of the local user, separate groupings of sensels may be constructed at respective locations on the display construct. In some embodiments, separate sensei groups are spaced apart from one another. Electronic switching of the outputs of separate groups of sensels may be used to select an effective camera height from different respective locations on the display construct. A continuous expanse of sensels may be utilized to cover an area greater than what is used at any one time, to capture an image. Electronic switching may select between different overlapping groups of sensels to choose from different heights, e.g., at a greater resolution.

In the example shown in FIG. 4, a high-magnification view 460 is shown of an integrated display and sensor construct 463 integrating light-emitting regions 461 with light-sensing regions 462. Integrated construct 463 may include a plurality of transparent layers joined together (e.g., as a laminate) and/or include an integrated glass unit (IGU). In the integrated construct, there may be a transparent substrate, transparent anode, transparent organic layer, and transparent cathode (e.g., of the tintable window such as an electrochromic window). Light-emitting regions 461 and light-sensing regions 462 may be formed on different substrates or on a common substrate. The integrated construct may be constructed such that external light sensed by the image sensing sensels first passes through at least a portion of the media display before reaching the sensels. Whether on the same or a different substrate, light-sensing regions 462 may be located offset from (e.g., between) light-emitting regions 461 (containing light emitting entities of the media display) when viewed in 2D from a location occupied by the user to be imaged.

In some embodiments, a transparent media display is used to enhance the immersive experience of a collaborative digital communication (e.g., video conference), e.g., by emulating the virtual participant's image with the local environment of the local participant(s), while stripping away incongruous elements of the remote environment of the remote participant(s) and/or auxiliary content to be presented (e.g., presentation, data sheet, article, picture, video, or any other document or exhibit). The media stream from the remote participant(s) may be altered before being displayed on the local transparent media display, e.g., by having a portion of the incoming information surrounding the material to be communicated (e.g., the virtual participant's image and/or auxiliary presentable content) removed. The removal of the incongruous content may facilitate retaining at least partial transparency of the media display in the area that was dedicated for the incongruous content. For example, emitting entities in the area of the media display in which the incongruous content should have been displayed, may be emitting dimmer light, or no light, e.g., to facilitate at least partial transparency of that area. The at least partial transparency of that area may facilitate viewing therethrough by a local viewer to provide an illusion that the virtual remote participant's image and/or auxiliary presentable content is disposed in the local environment. For example, a remote background around the virtual image of the remote user and/or remote presentation content, is replaced with a local (e.g., actual and real) view through the transparent display of a local environment of the local participant(s) (e.g., local viewer(s)). The area around the virtual remote participant's image and/or auxiliary content, may provide visibility of the local environment, e.g., to enhance an illusion that the remote user is present in the local environment. The virtual participant's image may be generated at an image scale that causes the size of the image on the local media display to be at or close to actual life-size. In some embodiments, physical furnishings are deployed in the local environment in ways that provide additional cues that further enhance the illusion. For example, a table or desk in the local environment placed in front of the media display may be oriented in an alignment that would extend into a plausible juxtaposition with the remote participant. For example, a virtual extension of the virtual perspective add-on overlay object (e.g., plant, or furniture such as a table) to the virtual image of the remote participant may be added. The virtual perspective object may provide an illusion of extension between the local participant(s) and the remote participant(s) and/or virtual remove auxiliar content. As another example, by including matching furnishings at multiple endpoints of a video conference (e.g., including a real table or desk in front of each real media display), each combined field of view for each respective participant (e.g., their view of their local environment combined with the virtual objects generated on their media display) can include the same matching desk or table on both sides of a video conference for creating a convincing telepresence illusion.

In some embodiments, virtual overlays are added to the displayed media stream that are configured to imitate the local environment (e.g., a ledge, a plant, or any other object). The virtual overlay object may match the aesthetics of the local environment. The virtual overlay may be added automatically and/or per user's request. The virtual overlay may be personalized and/or chosen by a suer such as the local participant(s) (e.g., using an App.). An overlay may be made to appear as an extension of a local furnishing (e.g., a virtual extension of a real local table or desk that is located in front of the local media display), or may represent a separate object (e.g., furnishing) having properties otherwise consistent with the local environment (e.g., aesthetic of the environment, usage of the environment, and/or purpose of the environment). The virtual overlay may be a perspective overlay. For example, a virtual overlay may be made to appear closer in the projected image to the viewing user (e.g., in front of the remote user in the projected image), thereby providing a virtual transition leading to the remote virtual image of the user and/or auxiliary content for presentation. Thus, a virtual object represented by the overlay may depict an object that spatially (e.g., perspectively) appears to be disposed between the local viewer(s) and the portion of the projected media stream displayed on the local media display that corresponds to the cut-out image of the remote participant and/or auxiliary content devoid of remote background. An overlay may be added to (e.g., merged with) a media stream, e.g., so that a virtual object is configured to flank a depiction of the virtual image of the remote participant and/or remote auxiliary content.

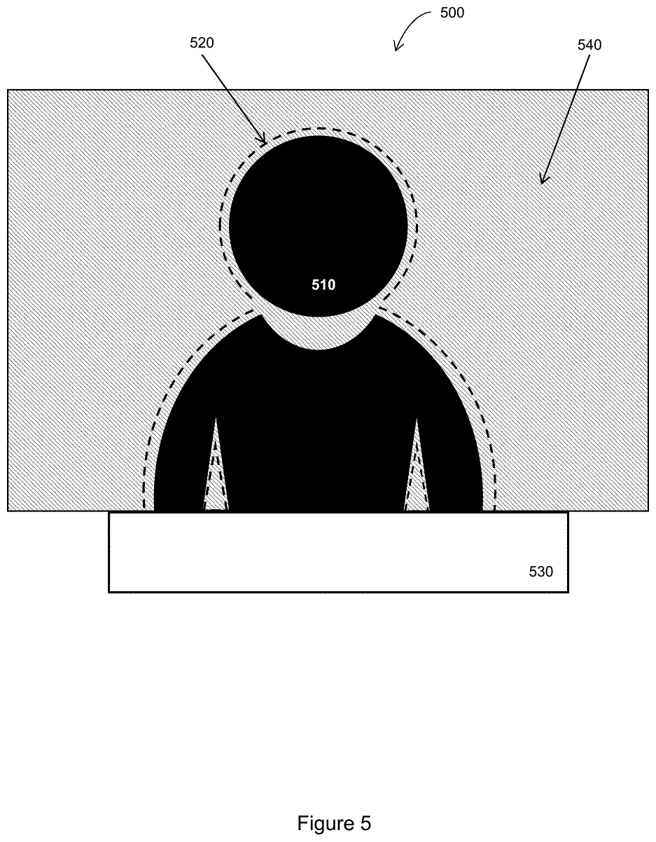

FIG. 5 shows an example media display 500 projecting a virtual image 510 of a remote user. A dashed line 520 shows a cutout profile bordering image 510 that delineates between a foreground region to be reproduced that includes the remote user and a background region for which no image is to be projected (e.g., unless an overlay is added). A table 530 is located as a real local furnishing of a local environment in front of media display 500. Area 540 of the media display represents a background that is redacted from the remote virtual image, and is left at least partially or entirely transparent, so that the real local environment can be viewed therethrough.

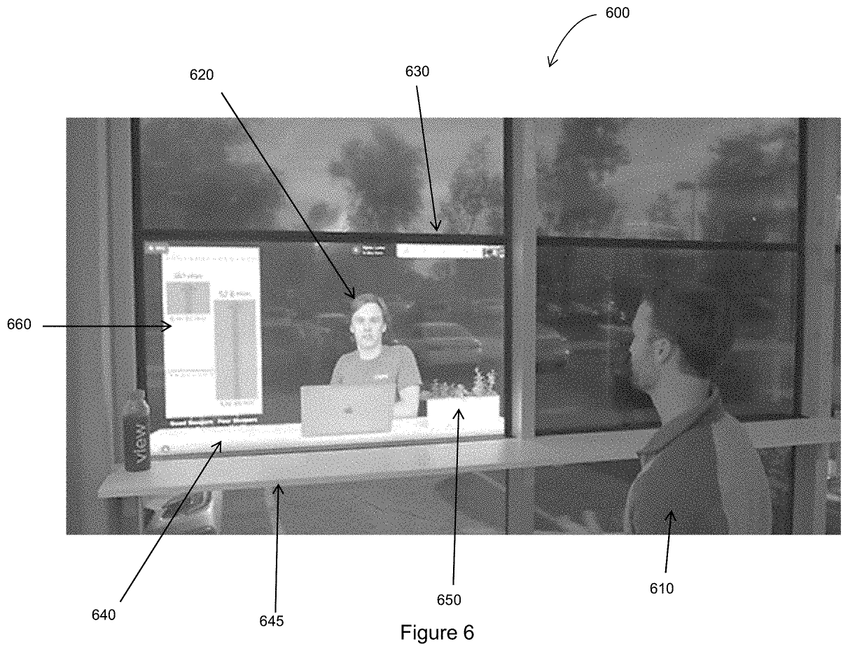

FIG. 6 depicts an example of a video conference in progress in a framing setup 600, which video conference is between a first local user 610 and a second remote user 620 presenting auxiliary content (e.g., data sheet) 660. A media display construct 630 disposed in front of local user 610 is projecting an image of user 620 along with a table overlay (e.g., a virtual table) 640 and a planter overlay (e.g., virtual planter) 650. A real ledge or table 645 is present in the local environment of user 610. Overlay 640 may depict a furnishing consistent with, and/or having an appearance of being a (e.g., perspective) extension of ledge 645.

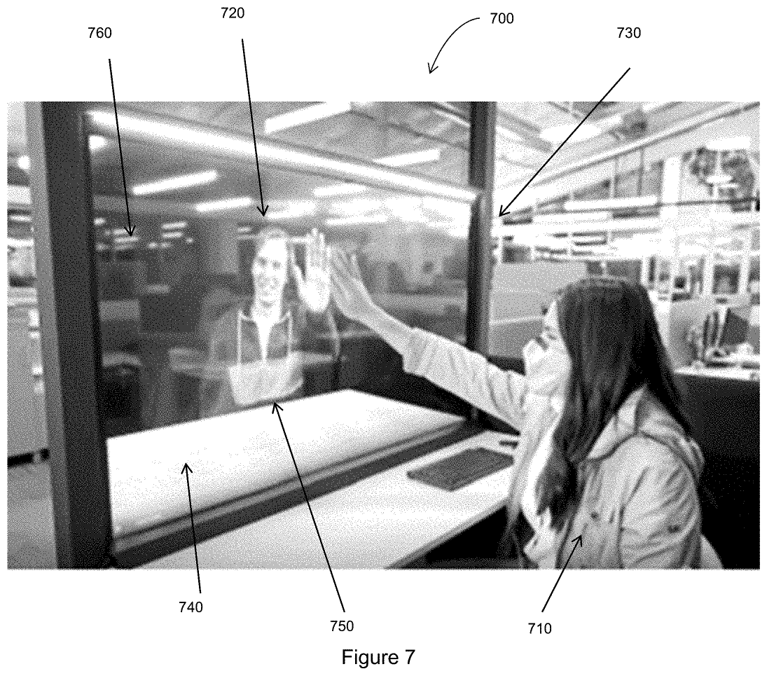

FIG. 7 depicts an example of a video conference 700 in progress between a first, local user 710 and a second, remote user 720. A media display construct 730 projects an image of user 720 along with a virtual table overlay 740, with the image of user 720 being cut-out and/or placed so that it does not overlap with overlay 740. User image 720 does not extend to the bottom edge of media display 730, but instead a lower edge of the cut-out coincides with an edge 750 of overlay 740. Thus, the illusion may be enhanced that makes remote user 720 appear to be farther away from local user 710 that the table or ledge represented by overlay 740. A background of remote user 720 is redacted such that user 710 can see the real local surrounding through portion 760 that forms the local background of the virtual image of remote user 720.

In some embodiments, shared auxiliary content is displayed to, and may optionally be manipulated by, participant(s) to a digital collaboration (e.g., simultaneously and/or in real time). At times, the right to manipulate the content can be restricted, e.g., by the presenter of the auxiliary content, according to a hierarchy of the participant(s) in the organization, and/or according to a hierarchy of the participants in the meeting. For example, a meeting organizer may have content manipulation rights, whereas a non-organizer may not. For example, a meeting presenter may have content manipulation rights of his presented content, whereas a non-presenter may not. For example, a manager participant may have content manipulation rights of his presented content, whereas a participant at a non-managerial position may not. The content manipulation rights may be prescribed manually (e.g., by the meeting organizer and/or presenter), e.g., before the meeting, during the meeting and/or in real time as the content is presented. The manipulation right prescription can be visible and/or manipulable via an app. The manipulation right prescription may be presented on the media display, e.g., during presentation (e.g., in a dropdown menu and/or screen). The app (e.g., application) may be executable on (i) a transitory processor such as of a smartphone, laptop, tablet, or (ii) other computing device of a participant. Auxiliary content may include text, graphic presentations, graphs, drawings, paintings, and/or a whiteboard capability. In some embodiments, a transparent display includes at least one region that has a touch screen functionality. A support app may be used that communicates with the media displays (e.g., with the controllers or image processors of the media displays). The support app can be configured to handle the auxiliary content (e.g., controlling access, creating and editing text, graphics, or other content). The support app may react to inputs generated by (e.g., each of) the participants (e.g., conveying content edits and/or modifying how the content is displayed) The support ap may relay the manipulation (e.g., revisions and/or comments) (I) to a central data source or (II) directly to (e.g., each) processor associated with the media display participating in the digital communication. The support app may provide functionality for defining (e.g., selecting from a menu) virtual elements to be displayed such as overlays (e.g., of furnishings, plants, or any other virtual objects). Selections defining a virtual environment may be made before, during, and/or after the digital communication (e.g., video conference) has launched. Configurations for particular media display systems (e.g., participant stations) and/or particular pairings of participant stations, may be stored for use in automatically configuring calls involving the stations. FIG. 6 depicts an example of a virtual document 660 being displayed on media display 630 being projected to user 610. A remote media display at a remote location of user 620 could likewise project an image of virtual document, e.g., similar to 660.

In some embodiments, Auxiliary content, the media display, the virtual overlays, or any combination thereof are controllable (e.g., manipulatable) using a digital twin of the enclosure in which the media display is disposed (e.g., in a touchless manner). The digital twin may include a database in a local server and/or in a cloud server, that stores content and/or rendering information that may be used to generate a representation of the auxiliary content to be shown on (e.g., each of) the media displays of the participants to a digital collaboration, and/or manipulation toolkit that can be utilized during the digital collaborative communication.

In some embodiments, when participants to a digital collaboration have determined a request to establish a video conference session, a support app and/or a digital twin is activated to configure details of the session. For example, network access information (e.g., addresses), media display and media streaming capabilities, image placement, elements of a virtual environment (e.g., overlays), and/or any pre-defined auxiliary content may optionally be defined using the support app. At an appointed time, the participants may take their places and launch their conference session via a network or networks (e.g., transport media and servers) linking their media displays (e.g., transparent displays, image sensors, controllers, and/or processors). Upon launch, media streams between the participant's media displays may be initiated such that a “cut-out” representation of remote participant(s) are projected on each transparent media display. For example, a portion of a media stream surrounding an image of the remote participant may be suppressed from being displayed, which suppression enables viewing at least a portion of the local environment through a portion of the local media display corresponding to the media stream portion that is suppressed. If selected (e.g., manually and/or automatically), appropriate overlays are merged with the media stream to respective media displays. The redacted (e.g., cut-out) representation of a participant may be captured using image sensor(s) that is located at a capture location that corresponds to a gazing region of the corresponding user directed towards the corresponding media display. The image sensor(s) may capture images through at least a portion of the transparent media display. The capture location(s) may be fixed or adjustable (e.g., manually and/or automatically adjustable). When an image sensor has an adjustable capture location then before or during a video conference session, the sensing location may be adjusted according to a direction in which the imaged user gazes towards the transparent media display. For example, the capture location may be adjusted to focus on a central, or on a substantially central, position such as (i) between pupils of the imaged user, (ii) between their brows, (iii) at the end of a nose bridge of the user, and/or (iv) any other capture location to focus, e.g., as disclosed herein. When a conference session includes auxiliary content, the touchscreen portions of the media display(s), a support app, and/or a virtual twin (e.g., data server), may be used to display and/or interact with the auxiliary content. The touchscreen portions of the media display(s), support app, and/or virtual twin, may be used to display and/or adjust virtual overlays before and/or during a conference session, e.g., if requested to enhance the integration of the immersive digital experience, for aesthetic considerations, for branding considerations, or just for fun.

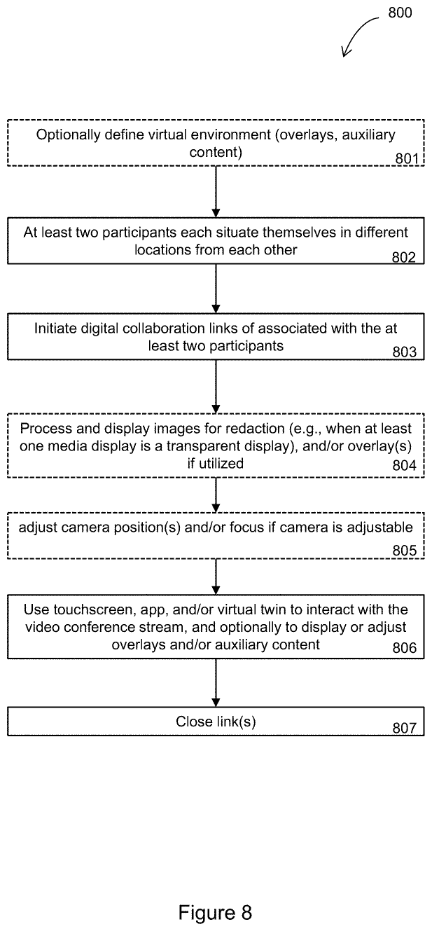

FIG. 8 shows an example of operations that may be performed in connection with a collaborative digital communication (e.g., video conference) session between remote participants. In an optional operation 801, a virtual environment may be defined (e.g., retrieved or selected) and optional auxiliary content may be set up and/or retrieved. At least two participants of the conference session in different (e.g., remote) locations, each situate themselves in proximity to a transparent media display and digital collaboration system in operation 802. In an operation 803, video conference links associated with the participants are initiated at each of the corresponding media display systems. During the conference session in an operation 804, images from respective media streams may be processed and displayed so that (i) if at least one of the media displays of the collaborative digital experience is a transparent display, background redacted (e.g., cut-out) images of the virtual image of the participant(s) displayed and/or any auxiliary content are displayed, and (iii) any selected overlays are displayed, on the respective media display. To provide accurate tracking of a participant's gaze, the positions and/or focus of any adjustable cameras may be adjusted in an operation 805. Camera adjustment may be vertical and/or horizontal, and may be manual and/or automatic. In an operation 806, a touchscreen, support app, and/or virtual twin may be used to interact with the video conference streams (e.g., to display, manipulate (e.g., adjust) overlays or auxiliary content). At the completion of the video conference session, the network links may be closed in operation 807. Preferences of participants, virtual overlays, camera, and/or media display setting may be stored (e.g., on the network).

In some embodiments, a digital twin (e.g., virtual twin) is used. The digital twin may provide a model of facility (e.g., comprising a building or buildings), including the structure of the facility, various (e.g., network-connected) devices in the facility, and network components in or coupled to the facility. In some embodiments, the digital twin includes representations of one or more transparent media display systems along with predetermined overlay(s). The digital twin may include a database for storing auxiliary content data, user preferences, media display preferences, camera preferences, and/or various definitions. The virtual model may comprise an electronic file associated with the facility, device(s), and/or network(s) such as a Building Information Model (BIM) (e.g., an Autodesk Revit® file or similar facility related file). A control interface to the digital twin can be configured to permit authorized users to initiate changes in the operation of various target devices (e.g., including media display(s)), e.g., since the digital twin links up each represented target element with (e.g., all) the needed information to select and/or control that target device (e.g., media display). For example, the target device may comprise a media display system. Users may initiate changes in how auxiliary content is displayed and/or changes to the auxiliary content itself. Via the media display system (e.g., using a touchscreen and/or via remote communication comprising gesture or sound recognition), a user may control any other device operatively coupled to the network, e.g., through the digital twin.

In some embodiments, dynamic elements in the digital twin include target (e.g., device) settings. The target setting may comprise (e.g., existing and/or predetermined): tint values, temperature settings, and/or light switch settings for the facility. The target settings may comprise available actions in media displays, such as controlling auxiliary content and/or overlays. The available actions may comprise menu items and/or hotspots in displayed content. The digital twin may include virtual representation of the target, of movable objects (e.g., chairs or doors), and/or of occupants (actual images from a camera or from stored avatars). In some embodiments, the dynamic elements can be targets (e.g., devices) that are newly plugged into the network, and/or disappear from the network (e.g., due to a malfunction or relocation). The digital twin can reside in any circuitry (e.g., processor) operatively coupled to the network. The circuitry in which the digital circuitry resides may be in the facility, outside of the facility, and/or in the cloud. In some embodiments, a two-way link is maintained between the digital twin and a real circuitry. The real circuitry may be part of the control system (e.g., of the facility). The real circuitry may be included in the master controller, network controller, floor controller, local controller, or in any other node in a processing system (e.g., in the facility or outside of the facility). For example, the two-way link can be used by the real circuitry to inform the digital twin of changes in the dynamic and/or static elements, e.g., so that the 3D representation of the enclosure can be updated (e.g., in real time). The two-way link may be used by the digital twin to inform the real circuitry of manipulative (e.g., control) actions entered by a user on a mobile circuitry. The mobile circuitry can be a remote controller (e.g., comprising a handheld pointer, manual input buttons, or touchscreen) that may execute the support app.

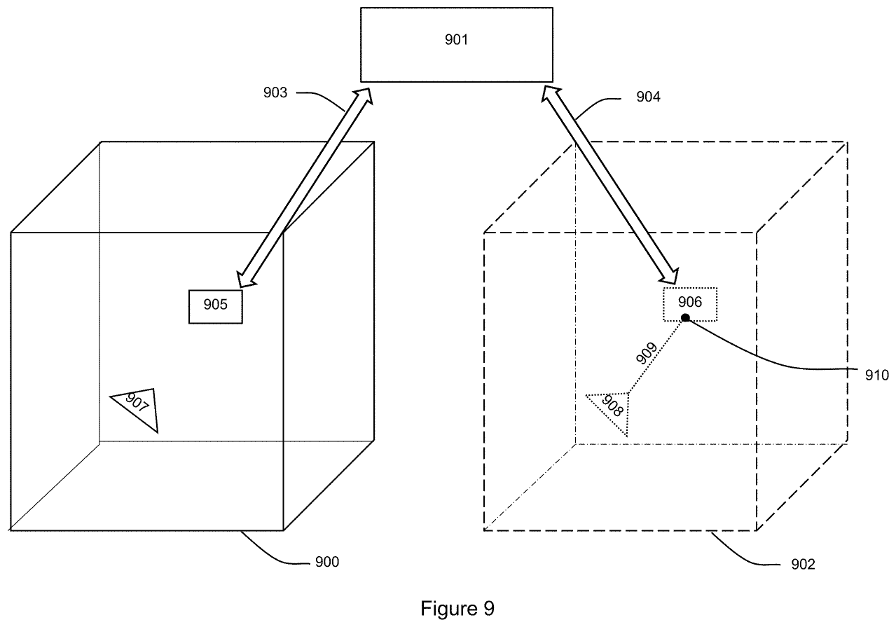

FIG. 9 shows an example of a control system in that a real, physical enclosure (e.g., room or building) 900 includes a controller network for managing interactive network devices under control of a processor 901 (e.g., a master controller). The structure and contents of building 900 are represented in a 3D model digital twin 902 as part of a modeling and/or simulation system executed by a computing asset. The computing asset may be co-located with, or remote from, enclosure 900 and processor (e.g., master controller) 901. A network link 903 in enclosure 900 connects processor 901 with a plurality of network nodes including an interactive target 905 such as a media display. Interactive target 905 is represented as a virtual object 906 in digital twin 902. A network link 904 connects processor 901 with digital twin 902. In some embodiments, the digital twin resides in processor 901.

In the example shown in FIG. 9, a user located in enclosure 900 carries a handheld control 907 that may have a circuitry (e.g., processor) for executing a support app and a pointing capability (e.g., to couple with the target 905). The location of handheld control 907 may be tracked, for example, via a network link with digital twin 902 (not shown). The link may include some transport media contained within network 903. Handheld controller 907 is represented as a virtual handheld controller 908 within digital twin 902. Based at least in part on the tracked location and pointing capability of handheld controller 907, when the user initiates a pointing event (e.g., aiming at a particular target and pressing an action button on the handheld controller) it is transmitted to digital twin 902. Accordingly, digital twin 902 may identify an intended action directed to a target (e.g., represented as a digital ray 909 from the tracked location in digital twin 902). Digital ray 909 intersects with virtual device 906 at a point of intersection 910. A resulting interpretation of actions made by the user in the digital twin 902 is reported by digital twin 902 to processor 901 via network link 904. In response, processor 901 relays a control message to interactive device 905 to initiate a commanded action, e.g., in accordance with a gesture (or other input action) made by the user using handheld controller 907.

In some embodiments, a video camera is placed behind a transparent display for capturing images of a local user. An immersive experience can be obtained when an image of a remote participant of a video conference is blended with a present (local) environment (real and/or augmented) using a transparent media display (e.g., TOLED). In some embodiments, the transparent display construct is coupled to a structure (e.g., a supportive structure that can be a fixture or a non-fixture). The structure (e.g., supportive structure) may comprise a window, a wall, or a board. The display construct may be coupled to the structure, e.g., with a fastener. There may be a distance between the display construct and the structure, e.g., when the display construct is operational. The distance may be at most about 0.5 meters (m), 0.4 m, 0.3 m, 0.2 m, 0.1 m, 0.05 m, 0.025 m, or 0.01 m. Examples of fasteners, media display, display construct, supportive structure, control system and network, can be found in International Patent Application Serial No. PCT/US20/53641, which is incorporated herein by reference in its entirety.

In some embodiments, a display construct that is coupled with a viewing (e.g., a tintable viewing) window. The viewing window may include an integrated glass unit. The display construct may include one or more glass panes.

In some embodiments, at least a portion of a window surface in a facility is utilized to display the various media using the glass display construct. The display may be utilized for (e.g., at least partial) viewing an environment external to the window (e.g., outdoor environment), e.g., when the display is not operating. The display may be used to display media (e.g., as disclosed herein), to augment the external view with (e.g., optical, real, and/or virtual) overlays, augmented reality, and/or lighting (e.g., the display may act as a light source). The media may be used for entertainment and non-entertainment purposes. The display may be used for medical, security, educational, informative, monetary, hospitality, and/or other purposes. The media may be used for work (e.g., data analysis, drafting, and/or video conferencing). The media may be manipulated (e.g., by utilizing the display construct, any control tools, gesture control, and/or related apps such as disclosed herein). Utilizing the display construct can be direct or indirect. Indirect utilization of the media may be using an input device such as via a mobile circuitry (e.g., controller) such as an electronic mouse, a stylus, or a keyboard. The input device may be communicatively (e.g., wired and/or wirelessly) coupled to the media. Direct utilization may be by using the display construct as a touch screen using a user (e.g., finger) or a directing device (e.g., an electronic pen or stylus). The directing device may be made or, and/or coated with a low abrasive material (e.g., a polymer). The low abrasive material may be configured to facilitate (e.g., repeatedly) contacting the display construct with minimal damage (e.g., scratching) to the display construct. the low abrasive material may comprise a polymer or resin (e.g., plastic). The directing device may be passive or active. The active directing device may operatively couple to the display construct and/or network. The active directing device may comprise a circuitry. The active directing device may comprise a remote controller. The directing device may facilitate direction of operations related to media presented by the display construct. The directing device may facilitate (e.g., real time and/or in situ) interaction with the media presented by the display construct. Examples of directing devices, control system and network, can be found in International Patent Application Serial No. PCT/US20/53641 which is incorporated herein by reference in its entirety. Examples of digital twin, gesture control, controlling circuitry (e.g., VR devices) service devices, target devices, control system and network, can be found in International Patent Application Serial No. PCT/US21/27418, which is incorporated herein by reference in its entirety.

Embodiments described herein relate to vision windows with a tandem (e.g., transparent) display construct. In certain embodiments, the vision window is a tintable window such as an electrochromic window. The electrochromic window may comprise a solid state and/or inorganic electrochromic (EC) device. The vision window may be in the form of an integrated glass unit (IGU). When the IGU includes an electrochromic (abbreviated herein as “EC”) device, it may be termed an “EC IGU.” The EC IGU can tint (e.g., darken) a room in which it is disposed and/or provide a tinted (e.g., darker) background as compared to a non-tinted IGU. The tinted IGU can provide a background preferable (e.g., necessary) for acceptable (e.g., good) contrast on the (e.g., transparent) display construct. In another example, windows with (e.g., transparent) display constructs can replace televisions (abbreviated herein as “TVs”) in commercial and residential applications. Together, the (e.g., transparent) display construct and the tintable window (e.g., in the form of EC IGU) can provide visual privacy glass function, e.g., because the display can augment the privacy provided by tintable window (e.g., EC window).

The display may be integrated as a display construct with window panel(s) (e.g., frame(s)). Examples of display constructs can be found in International Patent Application Serial No. PCT/US20/53641, which is incorporated herein by reference in its entirety.

In some embodiments, a display construct may include one or more glass panes. The display (e.g., display matrix) may comprise a light emitting diode (LED). The LED may comprise an organic material (e.g., organic light emitting diode abbreviated herein as “OLED”). The OLED may comprise a transparent organic light emitting diode display (abbreviated herein as “TOLED”), which TOLED is at least partially transparent. The display may have at its fundamental length scale 2000, 3000, 4000, 5000, 6000, 7000, or 8000 pixels. The display may have at its fundamental length scale any number of pixels between the aforementioned number of pixels (e.g., from about 2000 pixels to about 4000 pixels, from about 4000 pixels to about 8000 pixels, or from about 2000 pixels to about 8000pixels). A fundamental length scale may comprise a diameter of a bounding circle, a length, a width, or a height. The fundamental length scale may be abbreviated herein as “FLS.” The display construct may comprise a high resolution display. For example, the display construct may have a resolution of at least about 550, 576, 680, 720, 768, 1024, 1080, 1920, 1280, 2160, 3840, 4096, 4320, or 7680 pixels, by at least about 550, 576, 680, 720, 768, 1024, 1080, 1280, 1920, 2160, 3840, 4096, 4320, or 7680 pixels (at 30 Hz or at 60 Hz). The first number of pixels may designate the height of the display and the second pixels may designates the length of the display. For example, the display may be a high resolution display having a resolution of 1920×1080, 3840×2160, 4096×2160, or 7680×4320. The display may be a standard definition display, enhanced definition display, high definition display, or an ultra-high definition display. The display may be rectangular. The image projected by the display matrix may be refreshed at a frequency (e.g., at a refresh rate) of at least about 20 Hz, 30 Hz, 60 Hz, 70 Hz, 75 Hz, 80 Hz, 100 Hz, or 120 Hertz (Hz). The FLS of the display construct may be at least 20″, 25″, 30″, 35″, 40″, 45″, 50″, 55″, 60″, 65″, 80″, or 90 inches (″). The FLS of the display construct can be of any value between the aforementioned values (e.g., from about 20″ to about 55″, from about 55″ to about 100″, or from about 20″ to about 100″).

In some embodiments, at least a portion of a window surface in a facility is utilized to display the various media using the glass display construct. The display may be utilized for (e.g., at least partial) viewing an environment external to the window (e.g., outdoor environment), e.g., when the display is not operating. The display may be used to display media (e.g., as disclosed herein), to augment the external view with (e.g., optical) overlays, augmented reality, and/or lighting (e.g., the display may act as a light source). The media may be used for entertainment and non-entertainment purposes. The media may be used for work (e.g., data analysis, data processing, data manipulation, drafting, compilation, and/or video conferencing). The media may be manipulated (e.g., at least in part by utilizing the display construct). Utilizing the display construct can be direct or indirect. Indirect utilization of the media may be using an input device such as an electronic mouse, or a keyboard. The input device may be communicatively (e.g., wired and/or wirelessly) coupled to the media. Direct utilization may be by using the display construct as a touch screen using a user (e.g., finger) or a contacting device (e.g., an electronic pen or stylus).

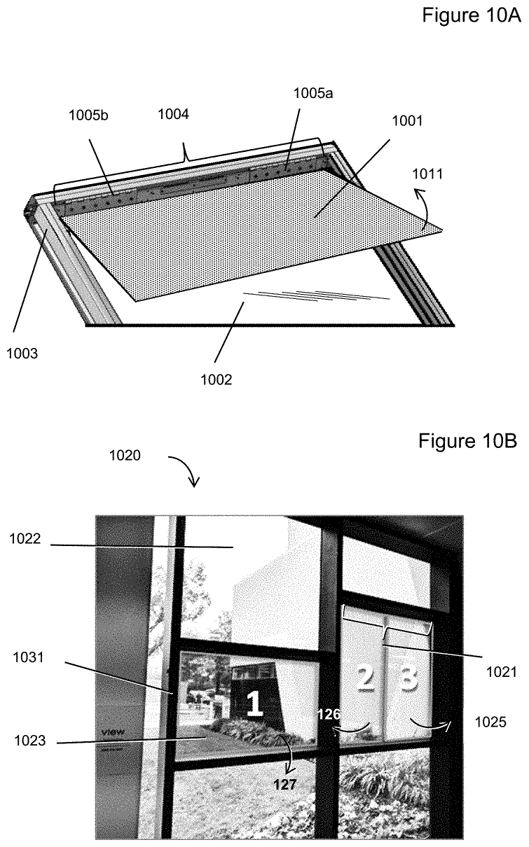

FIG. 10A shows an example of a window 1002 framed in a window frame 1003, and a fastener structure 1004 comprising a first hinge 1005a and a second hinge 1005b, which hinges facilitate rotating display construct 1001 about the hinge axis, e.g., in a direction of arrow 1011. The window may be a smart window such as an electrochromic (EC) window. The window may be in the form of an EC IGU. In one embodiment, mounted to window frame (e.g., 1003) is one or more display constructs (e.g., transparent display) (e.g., 1001) that is transparent at least in part. In one embodiment, the one or more display constructs (e.g., transparent display) comprises T-OLED technology, but it should be understood that the present invention should not be limited by or to such technology. In one embodiment, one or more display constructs (e.g., transparent display) is mounted to frame (e.g., 1003) via a fastener structure (e.g., 1004). In one embodiment the fastener structure (also referred to herein as a “fastener”) comprises a bracket. In one embodiment, the fastener structure comprises an L-bracket. In one embodiment, L-bracket comprises a length that approximates or equals a length of a side of window (e.g., and in the example shown in FIG. 10A, also the length of the fastener 1004). In embodiments, the fundamental length scale (e.g., length) of a window is at most about 60 feet (′), 50′, 40′, 30′, 25′, 20′, 15′, 10′, 5′ or 1′. The FLS of the window can be of any value between the aforementioned values (e.g., from 1′ to 60′, from 1′ to 30′, from 30′ to 60′, or from 10′ to 40′). In embodiments, the fundamental length scale (e.g., length) of a window is at least about 60′, 80′, or 100′. In one embodiment, the display construct (e.g., transparent display) encompasses an area that (e.g., substantially) matches a surface area of the lite (e.g., pane).

FIG. 10B shows an example of various windows in a facade 1020 of a building, which facade comprises windows 1022, 1023, and 1021, and display constructs 1, 2, and 3. In the example shown in FIG. 10B, display construct 1 is transparent at least in part and is disposed over window 1023 (e.g., display construct 1 is super positioned over window 1023) such that the entirety of window 1023 is covered by the display construct, and a user can view through the display construct 1 and the window 1023 the external environment (e.g., flowers, glass, and trees). Display construct 1 is coupled to the window with a fastener that facilitates rotation of the display construct about an axis parallel to the window bottom horizontal edge, which rotation is in the direction of arrow 1027. In the example shown in FIG. 10B, display constructs 2 and 3 are transparent at least in part and are disposed over window 1021 such that the entirety of window 1021 is covered by the two display construct each covering (e.g., extending to) about half of the surface area of window 1021, and a user can view through the display constructs 2 and 3 and the window 1021 the external environment (e.g., flowers, glass, and trees). Display construct 2 is coupled to the window 1021 with a fastener that facilitates rotation of the display construct about an axis parallel to the window left vertical edge, which rotation is in the direction of arrow 1026. Display construct 3 is coupled to the window with a fastener that facilitates rotation of the display construct about an axis parallel to the window 1021 right vertical edge, which rotation is in the direction of arrow 1025.

In some embodiments, the display construct comprises a hardened transparent material such as plastic or glass. The glass may be in the form of one or more glass panes. For example, the display construct may include a display matrix (e.g., an array of lights) disposed between two glass panes. The array of lights may include an array of colored lights. For example, an array of red, green, and blue colored lights. For example, an array of cyan, magenta, and yellow colored lights. The array of lights may include light colors used in electronic screen display. The array of lights may comprise an array of LEDs (e.g., OLEDs, e.g., TOLEDs). The matrix display (e.g., array of lights) may be at least partially transparent (e.g., to an average human eye). The transparent OLED may facilitate transition of a substantial portion (e.g., greater than about 30%, 40%, 50%, 60%, 80%, 90% or 95%) of the intensity and/or wavelength to which an average human eye senses. The matrix display may form minimal disturbance to a user looking through the array. The array of lights may form minimal disturbance to a user looking through a window on which the array is disposed. The display matrix (e.g., array of lights) may be maximally transparent. At least one glass pane of the display construct may be of a regular glass thickness. The regular glass may have a thickness of at least about 1 millimeters (mm), 2 mm, 3 mm, 4 mm, 5 mm, or 6 mm. The regular glass may have a thickness of a value between any of the aforementioned values (e.g., from 1 mm to 6 mm, from 1 mm to 3 mm, from 3 mm to about 4 mm, or from 4 mm to 6 mm). At least one glass pane of the display construct may be of a thin glass thickness. The thin glass may have a thickness of at most about 0.4 millimeters (mm), 0.5 mm, 0.6 mm, 0.7 mm, 0.8 mm, or 0.9 mm thick. The thin glass may have a thickness of a value between any of the aforementioned values (e.g., from 0.4 mm to 0.9 mm, from 0.4 mm to 0.7 mm, or from 0.5 mm to 0.9 mm). The glass of the display construct may be at least transmissive (e.g., in the visible spectrum). For example, the glass may be at least about 80%, 85%, 90%, 95%, or 99% transmissive. The glass may have a transmissivity percentage value between any of the aforementioned percentages (e.g., from about 80% to about 99%). The display construct may comprise one or more panes (e.g., glass panes). For example, the display construct may comprise a plurality (e.g., two) of panes. The glass panes may have (e.g., substantially) the same thickness, or different thickness. The front facing pane may be thicker than the back facing pane. The back facing pane may be thicker than the front facing pane. Front may be in a direction of a prospective viewer (e.g., in front of display construct 1001, looking at display construct 1001). Back may be in the direction of a (e.g., tintable) window (e.g., 1002). One glass may be thicker relative to another glass. The thicker glass may be at least about 1.25*, 1.5*, 2*, 2.5*, 3*, 3.5*, or 4* thicker than the thinner glass. The symbol “*” designates the mathematical operation of “times.” The transmissivity of the display construct (that including the one or more panes and the display matrix (e.g., light-array or LCD)) may be of at least about 20%, 30%, 35%, 40%, 45%, 50%, 60%, 70%, 80%, or 90%. The display construct may have a transmissivity percentage value between any of the aforementioned percentages (e.g., from about 20% to about 90%, from about 20% to about 50%, from about 20% to about 40%, from about 30% to about 40%, from about 40% to about 80%, or from about 50% to about 90%). A higher transmissivity parentage refers higher intensity and/or broader spectrum of light that passes through a material (e.g., glass). The transmissivity may be of visible light. The transmissivity may be measured as visible transmittance (abbreviated herein as “Tvis”) referring to the amount of light in the visible portion of the spectrum that passes through a material. The transmissivity may be relative to the intensity of incoming light. The display construct may transmit at least about 80%, 85%, 90%, 95%, or 99% of the visible spectrum of light (e.g., wavelength spectrum) therethrough. The display construct may transmit a percentage value between any of the aforementioned percentages (e.g., from about 80% to about 99%). In some embodiments, instead of an array of lights, a liquid crystal display is utilized.

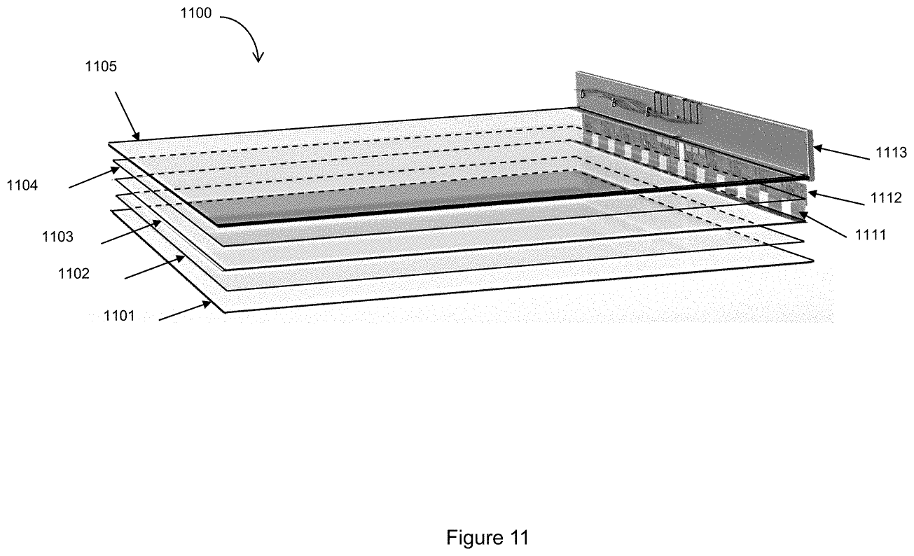

FIG. 11 shows a schematic example of a display construct assembly (e.g., laminate) 1100 prior to its lamination, which display construct that includes a thicker glass pane 1105, a first adhesive layer 1104, a display matrix 1103, a second adhesive layer 1102, and a thinner glass pane 1101, which matrix is connected via wiring 1111 to a circuitry 1112 that controls at least an aspect of the display construct, which display construct is coupled to a fastener 1113.

In some embodiments, gesture command is used for controlling a mobile circuitry or other interface that controls a video conference session, the real or virtual environments, and/or auxiliary content. A sensor (e.g., an image sensor) may be used instead of (or in addition to) a microphone, to perceive and record the user's command. The mobile circuitry may be communicatively coupled to the network that is communicatively coupled to a digital twin of the enclosure in which the target is disposed. Instead of a voice recognition module, a gesture recognition module may be employed for analyzing the mobile circuitry and/or sensor (e.g., camera) data. For example, a user may be positioned within a field of view of a camera so that movements of the user can be captured which are carried out according to a requested control action to be taken in connection with controllable targets (e.g., devices) such as tintable windows. For example, movements of the user can be captured by the mobile device manipulated by the user (e.g., moved by the user) that are carried out according to a requested control action to be taken in connection with controllable targets (e.g., devices) such as tintable windows. Examples of digital twin, gesture control, controlling circuitry (e.g., VR devices) service devices, target devices, control system and network, can be found in International Patent Application Serial No. PCT/US21/27418, which is incorporated herein by reference in its entirety.

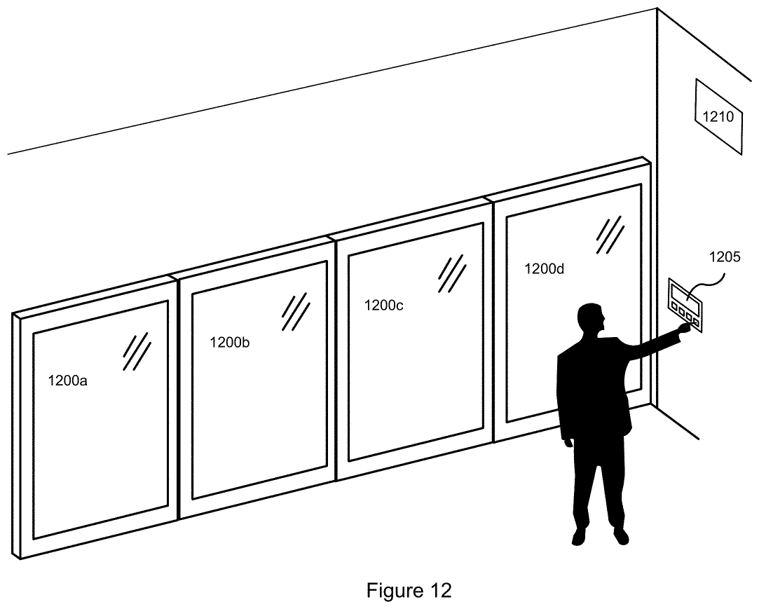

FIG. 12 shows an example of a user interacting with a device 1205 for controlling status of a target that is the optical state of electrochromic windows 1200a-1200d. In this example, the device 1205 is a wall device as described above. In some embodiments, the wall device 1205 is or includes a smart device such as an electronic tablet or similar device. Device 1205 may be a device configured to control the electrochromic windows 1200a-1200d, including but not limited to a smartphone, tablet, laptop, PC, etc. The device 1205 may run an application/program that is configured to control the electrochromic windows. In some embodiments, the device 1205 communicates with an access point 1210, for example through a wired connection or a wireless connection (e.g., WiFi, Bluetooth, Bluetooth low energy, ZigBee, WiMax, etc.). The wireless connection can allow at least one apparatus (e.g., target apparatus) to connect to the network, internet, and/or communicate with one another wirelessly within an area (e.g., within a range). The access point 1210 may be a networking hardware device that allows a wireless technology (e.g., Wi-Fi) compliant device to connect to a wired network. The device 1205 may communicate with a controller (e.g., of a control system such as a window controller, network controller, and/or master controller) through a connection scheme.

Embodiments of the invention may be scalable to adapt an immersive experience according to a number of participants in a video conference. Media display systems and associated furnishings can be tailored to varying collaboration modalities to accommodate group sizes and/or different types of meetings. In an office setting, a plurality of conferencing units or stations having a variety of adaptations for differently sized groups of participants may be deployed in a space-efficient manner. In some embodiments, an individual portal is constructed with room for a single local participant. An individual portal may be free-standing in an open space of a room for quick communications and/or to facilitate a few local participants sharing a conference with remote parties. The individual portal may be constructed with isolation walls or panels around at least one side of the media display to provide audio and video privacy and/or to reduce the possibility of spreading contagions within an office. In some embodiments, small group nooks (e.g., pods) are provided with room for a few participants (e.g., maintaining a separation for social distancing). More than one media display may be deployed in a pod to facilitate the participation of multiple remote participants (e.g., each being shown life-size on a respective media display). In some embodiments, a modality is provided in which a greater number of transparent media display constructs are deployed for large group zones or huddle spaces. In each modality, transparent media displays can be incorporated into freestanding panels in building interiors or into a supportive structure such as an architectural (e.g., externally bordering) glass. The different sizes of conferencing stations can be adapted for particular functions. For example, a layout of media displays and/or the associated furnishing can be configured for supporting reception services or for acting as distribution (e.g., postal, inventory, sales, merchandise) hubs.

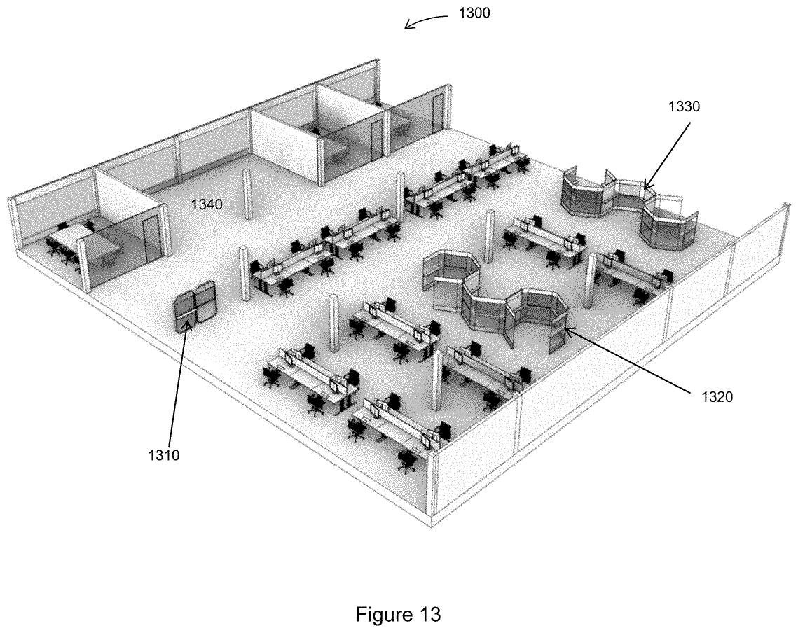

FIG. 13 shows an example floorplan 1300 of an office setting (e.g., an office suite). Floorplan 1300 includes a pair of freestanding, individual portals such as 1310. Small group pods are combined (e.g., sharing some walls) into space-efficient groupings 1320 and 1330. A large open area 1340 may be fitted with an array of media displays to provide immersive conferencing between groups of local and remote participants.

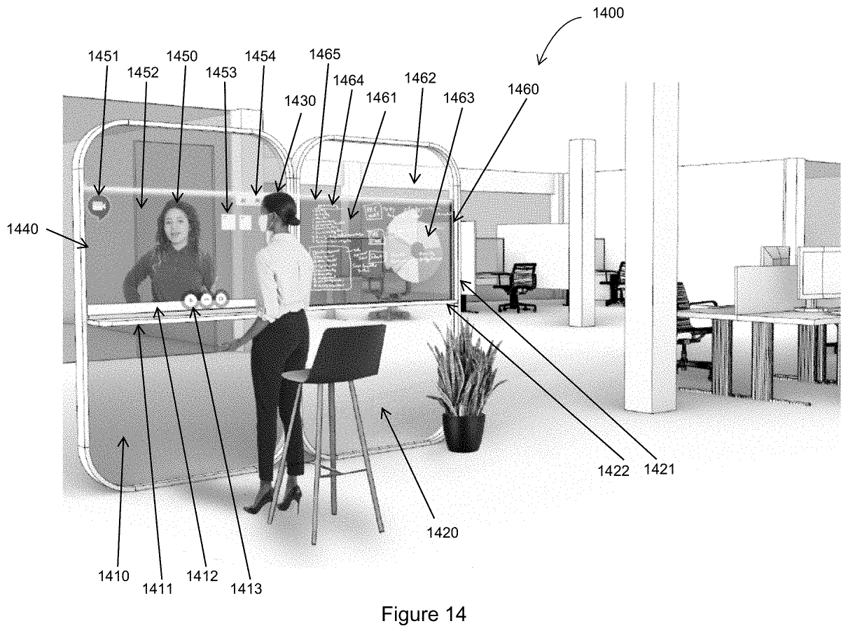

FIG. 14 shows a portion of a floorplan section 1400 in greater detail with side-by-side freestanding, individual portals 1410 and 1420 having transparent supportive structures such as 1462. Portal 1410 includes a physical ledge 1411 on which a mobile object can be placed (e.g., laptop or cellphone). The mobile platform can include a wireless charger. A local user 1430 utilizes a transparent media display 1440 in portal 1410 to view a media stream including a remote user 1450 and auxiliary content 1453. The remote background is redacted from an image stream of the remote program and is not projected on media display 1440, thus facilitating viewing through the redacted area 1452 of the remote media stream. Media display 1440 is a transparent media display that project in addition to the redacted remote media stream, also icons 1451, 1454, and 1413 that facilitate control of various aspects associated with the digital communication, and virtual overlay 1412. Icon 1451 facilitates control of the video camera capturing user 1430 (e.g., adjustment of the camera's focus, height, and/or its usage). Icons 1413 can facilitate various aspects of the communication such as capturing a screenshot, adjusting volume, and commenting. Icons 1454 can facilitate annotation and/or other manipulation of items presented during the digital interaction such as documents 1453. To provide greater space of conveying auxiliary content, a media display 1460 of portal 1420 can be rolled into the video conferencing session (e.g., as a screen extension and/or a second screen) e.g., so that the remote user and the auxiliary content can be show at a large (e.g., actual size) size simultaneously. The second media display 1420 includes auxiliary content 1463, notes, and annotations 1463 (e.g., by the local and/or remote user). Media display 1460 excludes any background, and thus the local background 1461 can be viewed through transparent display 1460. Transparent displays 1440 and 1460 are bordered by a line of light (e.g., fluorescent or LED light) such as 1465, and by framing such as 1421 that hold the transparent display in conjunction with the transparent supportive structure such as 1462. Portals 1410 and 1420 also include panel caps such as 1422, thorough which wiring can go through and/or local controllers can reside. The wires can also run through the panel framing such as 1421. The local controller (e.g., of the media display(s) may reside in the panel caps and/or in the portal framing. Examples of panel caps, controllers, wiring, and wiring guides can be found in International Patent Application Serial. No. PCT/US20/53641, which is incorporated herein by reference in its entirety. Examples of wireless chargers, controllers, mobile circuitry, network, controllers, framing systems, and devices (e.g., display construct, and tintable windows) can be found in U.S. Patent Application Ser. No. 63/170,245 filed, Apr. 2, 2021, titled “DISPLAY CONSTRUCT FOR MEDIA PROJECTION AND WIRELESS CHARGING,” which is incorporated herein by reference in its entirety.

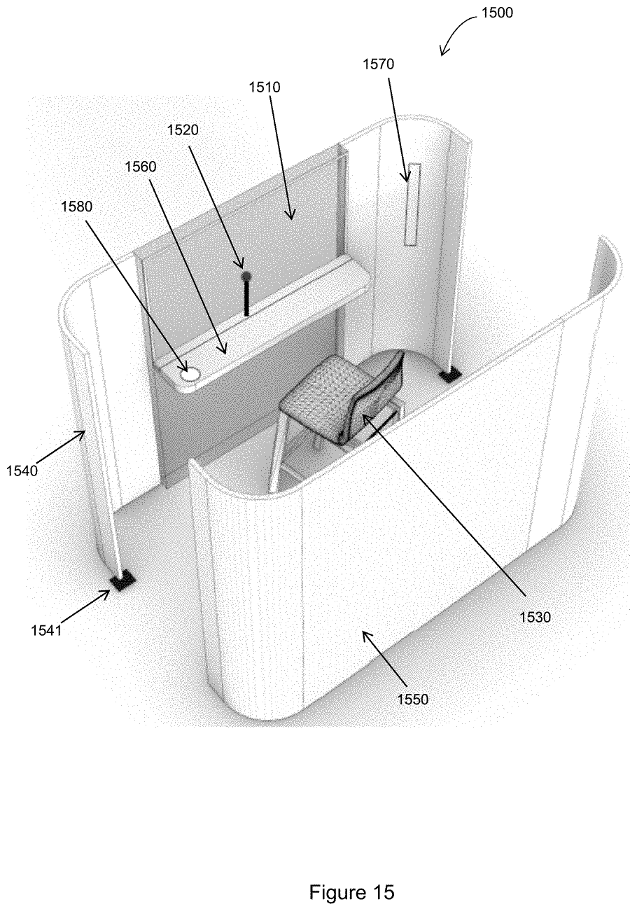

FIG. 15 shows an example of a personal portal 1500 with enhanced privacy. A transparent media display 1510 and a video image sensor 1520 (e.g., behind display 1510) are arranged for utilization by a user within a single seat 1530. Privacy panels 1540 and 1550 may comprise sound dampening materials, e.g., to provide a quiet space for conducting a conference and/or to limit propagation of sound outside portal 1500. For enhancing an immersive experience, a table ledge 1560 in front of media display 1510 can be duplicated at the remote location(s) (e.g., when collaborating with users having a similarly constructed portal). The table ledge may comprise a wireless charging stations (not shown). Lighting 1570 may be provided to help ensure a good quality media stream is obtained by camera 1520. A loudspeaker 1580 may provide sound output, and/or a personal headphone can be provided with audio content (e.g., using a Bluetooth connection). Camera 1520 may have a fixed focus (e.g., set to avoid image degradation from viewing through the pixels of media display 1510), or may have an adjustable focus. Camera 1520 may be horizontally and/or vertically adjustable (e.g., by the user). Camera 1520 may have a wide field-of-view to capture table ledge 1560. Wiring of the network (e.g., power and/or communication) may run thought the walls of personal portal 1500 such as panel 1540, and connect to the network via connector 1541 disposed on the floor. In other embodiments, the connection may be to a wall or to a ceiling of the facility. Personal portal 1500 may be operatively coupled to the network (e.g., external network and/or local network of the facility).

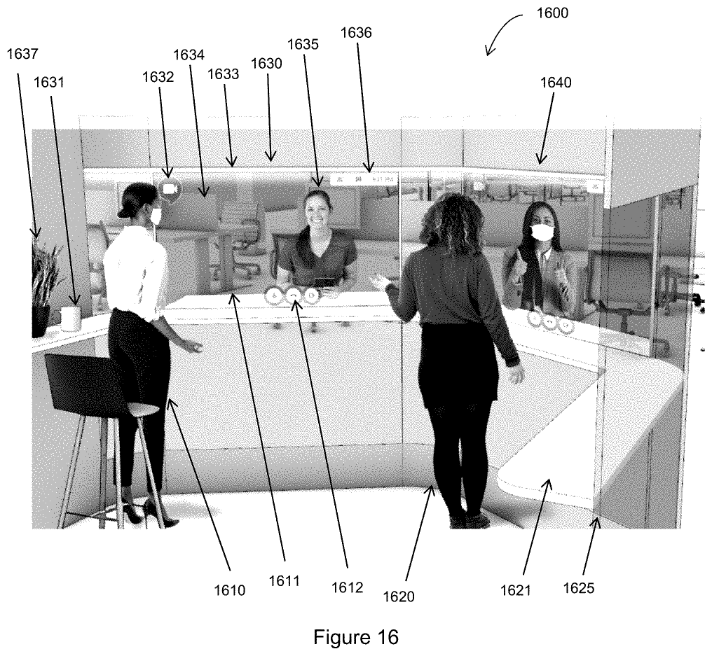

FIG. 16 shows an example of a group pod 1600 with space for accommodating local users such as 1610 and 1620. Pod 1600 includes at least two transparent media displays such as 1630 and 1640 for displaying media streams from respective remote users (e.g., at different remote locations). Even when the multiple remote environments have a different appearance from the local environment and from each other, each participant having a transparent display such as participants 1610 and 1620, may experience all participants as though they shared a local environment, as the remote background of remote participants is redacted, thus allowing the local environment to show through the redacted remote background portion of the media stream, as in 1634. The media display 1630 displays a remote participant 1635, local camera controls 1632, lighting panel 1633, dropdown and/or informative menu 1636 that includes chat, participants data, and timing information. Media display 1630 also displays ledge perspective overlay 1611 and icons 1612 that facilitate voice and streaming control. Media display 1640 has displays similar features. Group pod 1600 includes a physical ledge 1621 on which objects such as public items (e.g., plant 1637), and personal items (e.g., cup 1631) can be placed. Group pod 1600 includes transparent supportive panels such as 1625. IN other embodiments, at least one of the transparent supportive panels can be substituted by a non-transparent (e.g., opaque) supportive panel. The supportive panel can comprise gypsum, cardboard, cork, plaster, a polymer (e.g., plastic), a ceramic, a composite material, a metal (e.g., elemental metal and/or metal alloy), or glass. The supportive panel can comprise a glossy or matt exposed surface. The exposed surface of at least a portion of the supportive structure can be planar or rough. At least a portion of the exposed surface of the supportive structure may be dispersive, transmissive, or reflective. The physical ledge may comprise a (e.g., wireless) charging station. Group pod 1600 may comprise wiring (e.g., in its walls, framing, and/or framing caps).

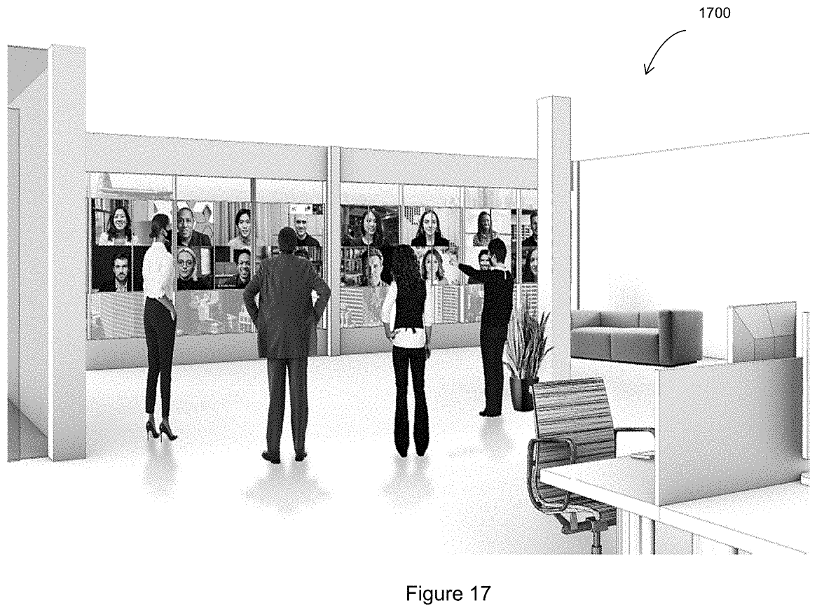

FIG. 17 shows an example of a large group huddle space 1700 that may achieve an immersive experience for local and remote participants by employing transparent media displays so that (1) remote users and/or remote auxiliary content are shown as cutouts that integrate with a local environment in which their remote background is redacted, and/or (2) camera(s) imaging the local and/or remote participants can obtain media streams in which the imaged participants are directing their gaze toward the camera.

In some embodiments, a transparent media display is combined with a tintable window (e.g., an electrochromic window). In some embodiments, a dynamic state of an electrochromic window is controlled by altering a voltage signal to an electrochromic device (ECD) used to provide tinting or coloring. An electrochromic window can be manufactured, configured, or otherwise provided as an insulated glass unit (IGU). IGUs may serve as the fundamental constructs for holding electrochromic panes (also referred to as “lites”) when provided for installation in a building. An IGU lite or pane may be a single substrate or a multi-substrate construct, such as a laminate of two substrates. IGUs, especially those having double- or triple-pane configurations, can provide a number of advantages over single pane configurations; for example, multi-pane configurations can provide enhanced thermal insulation, noise insulation, environmental protection and/or durability when compared with single-pane configurations. A multi-pane configuration also can provide increased protection for an ECD, for example, because the electrochromic films, as well as associated layers and conductive interconnects, can be formed on an interior surface of the multi-pane IGU and be protected by an inert gas fill in the interior volume of the IGU.

Certain disclosed embodiments provide a network infrastructure in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, transmitter, receiver, radio, processor and/or controller (that may comprise a processor). The network infrastructure may be operatively coupled to, and/or include, a wireless network. The network infrastructure may comprise wiring. One or more sensors can be deployed (e.g., installed) in an environment as part of installing the network and/or after installing the network. The network may be a local network. The network may comprise a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. The communication may comprise media communication facilitating stills, music, or moving picture streams (e.g., movies or videos). The communication may comprise data communication (e.g., sensor data). The communication may comprise control communication, e.g., to control the one or more nodes operatively coupled to the networks. The network may comprise a first (e.g., cabling) network installed in the facility. The network may comprise a (e.g., cabling) network installed in an envelope of the facility (e.g., such as in an envelope of an enclosure of the facility. For example, in an envelope of a building included in the facility).

In various embodiments, a network infrastructure supports a control system for one or more windows such as tintable (e.g., electrochromic) windows. The control system may comprise one or more controllers operatively coupled (e.g., directly or indirectly) to one or more windows. While the disclosed embodiments describe tintable windows (also referred to herein as “optically switchable windows,” or “smart windows”) such as electrochromic windows, the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). The tintable window may be disposed in a (non-transitory) facility such as a building, and/or in a transitory facility (e.g., vehicle) such as a car, RV, bus, train, airplane, helicopter, ship, or boat.

In some embodiments, a tintable window exhibits a (e.g., controllable and/or reversible) change in at least one optical property of the window, e.g., when a stimulus is applied. The change may be a continuous change. A change may be to discrete tint levels (e.g., to at least about 2, 4, 8, 16, or 32 tint levels). The optical property may comprise hue, or transmissivity. The hue may comprise color. The transmissivity may be of one or more wavelengths. The wavelengths may comprise ultraviolet, visible, or infrared wavelengths. The stimulus can include an optical, electrical and/or magnetic stimulus. For example, the stimulus can include an applied voltage and/or current. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through the window. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC”). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. patent application Ser. No. 14/443,353, filed May 15, 2015, now U.S. Pat. No. 10,359,681, issued Jul. 23, 2019, filed May 15, 2015, titled “MULTI-PANE WINDOWS INCLUDING ELECTROCHROMIC DEVICES AND ELECTROMECHANICAL SYSTEMS DEVICES,” and incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD, or “EC”). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g., noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD).

In some implementations, suitable ions include cations. The cations may include lithium ions (Li+) and/or hydrogen ions (H+) (i.e., protons). In some implementations, other ions can be suitable. Intercalation of the cations may be into an (e.g., metal) oxide. A change in the intercalation state of the ions (e.g., cations) into the oxide may induce a visible change in a tint (e.g., color) of the oxide. For example, the oxide may transition from a colorless to a colored state. For example, intercalation of lithium ions into tungsten oxide (WO3-y (0<y≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

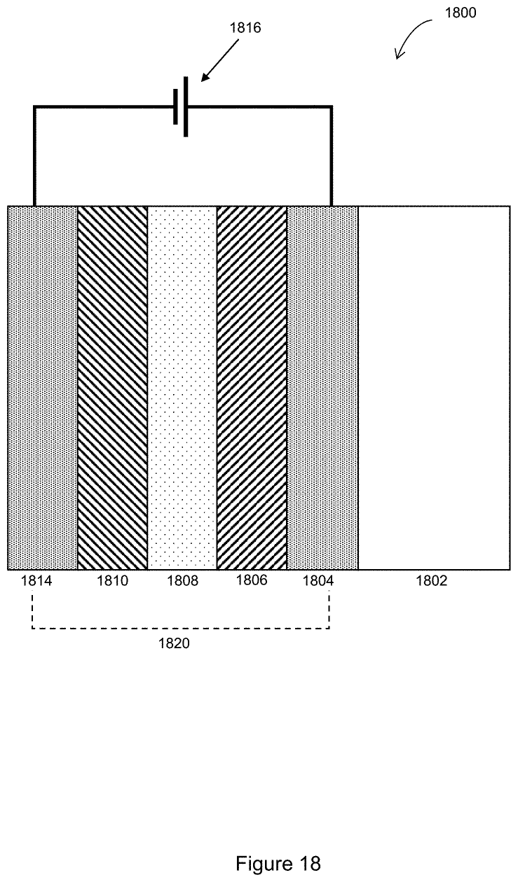

FIG. 18 shows an example of a schematic cross-section of an electrochromic device 1800 in accordance with some embodiments. The EC device coating is attached to a substrate 1802, a transparent conductive layer (TCL) 1804, an electrochromic layer (EC) 1806 (sometimes also referred to as a cathodically coloring layer or a cathodically tinting layer), an ion conducting layer or region (IC) 1808, a counter electrode layer (CE) 1810 (sometimes also referred to as an anodically coloring layer or anodically tinting layer), and a second TCL 1814. Elements 1804, 1806, 1808, 1810, and 1814 are collectively referred to as an electrochromic stack 1820. A voltage source 1816 operable to apply an electric potential across the electrochromic stack 1820 effects the transition of the electrochromic coating from, e.g., a clear state to a tinted state. In other embodiments, the order of layers is reversed with respect to the substrate. That is, the layers are in the following order: substrate, TCL, counter electrode layer, ion conducting layer, electrochromic material layer, TCL. In various embodiments, the ion conductor region (e.g., 1808) may form from a portion of the EC layer (e.g., 1806) and/or from a portion of the CE layer (e.g., 1810). In such embodiments, the electrochromic stack (e.g., 1820) may be deposited to include cathodically coloring electrochromic material (the EC layer) in direct physical contact with an anodically coloring counter electrode material (the CE layer). The ion conductor region (sometimes referred to as an interfacial region, or as an ion conducting substantially electronically insulating layer or region) may form where the EC layer and the CE layer meet, for example through heating and/or other processing steps. Examples of electrochromic devices (e.g., including those fabricated without depositing a distinct ion conductor material) can be found in U.S. patent application Ser. No. 13/462,725 filed May 2, 2012, titled “ELECTROCHROMIC DEVICES,” that is incorporated herein by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack 1820. Various layers, including transparent conducting layers (such as 1804 and 1814), can be treated with anti-reflective and/or protective layers (e.g., oxide and/or nitride layers).

In some embodiments, an IGU includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electrical leads may operatively couple (e.g., connect) one or more electrochromic devices to a voltage source, switches and the like, and may include a frame that supports the IGU or laminate. A window assembly may include a window controller, and/or components of a window controller (e.g., a dock).

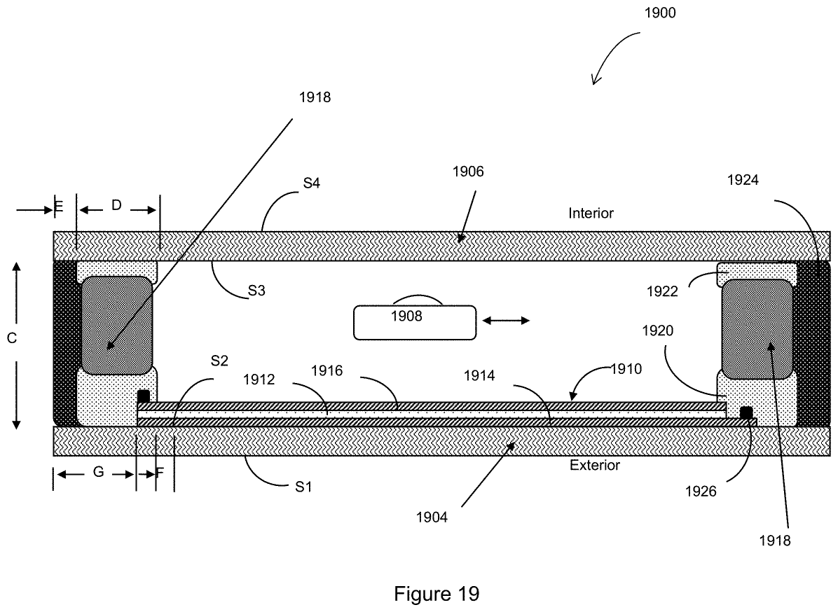

FIG. 19 shows an example implementation of an IGU 1900 that includes a first pane 1904 having a first surface S1 and a second surface S2. In some implementations, the first surface S1 of the first pane 1904 faces an exterior environment, such as an outdoors or outside environment. The IGU 1900 also includes a second pane 1906 having a first surface S3 and a second surface S4. In some implementations, the second surface S4 of the second pane 1906 faces an interior environment, such as an inside environment of a home, building or vehicle, or a room or compartment within a home, building or vehicle.

In some embodiments, (e.g., each of the) first and/or the second panes 1904 and 1906 are transparent and/or translucent to light, e.g., in the visible spectrum. For example, (e.g., each of the) first and/or second panes 1904 and 1906 can be formed of a glass material (e.g., an architectural glass or other shatter-resistant glass material such as, for example, a silicon oxide (SOₓ)-based glass material. The (e.g., each of the) first and/or second panes 1904 and 1906 may be a soda-lime glass substrate or float glass substrate. Such glass substrates can be composed of, for example, approximately 75% silica (SiO₂) as well as Na₂O, CaO, and several minor additives. However, the (e.g., each of the) first and/or the second panes 1904 and 1906 can be formed of any material having suitable optical, electrical, thermal, and mechanical properties. For example, other suitable substrates that can be used as one or both of the first and the second panes 1904 and 1906 can include other glass materials as well as plastic, semi-plastic and thermoplastic materials (for example, poly(methyl methacrylate), polystyrene, polycarbonate, allyl diglycol carbonate, SAN (styrene acrylonitrile copolymer), poly(4-methyl-1-pentene), polyester, polyamide), and/or mirror materials. In some embodiments, (e.g., each of the) first and/or the second panes 2204 and 2206 can be strengthened, for example, by tempering, heating, or chemically strengthening.

In the example shown in FIG. 19, first and second panes 1904 and 1906 are spaced apart from one another by a spacer 1918, which is typically a frame structure, to form an interior volume. In some embodiments, the interior volume is filled with Argon (Ar) or another gas, such as another noble gas (for example, krypton (Kr) or xenon (Xn)), another (non-noble) gas, or a mixture of gases (for example, air). Filling the interior volume with a gas such as Ar, Kr, or Xn can reduce conductive heat transfer through the IGU 1900. Without wishing to be bound to theory, this may be because of the low thermal conductivity of these gases as well as improve acoustic insulation, e.g., due to their increased atomic weights. In some embodiments, the interior volume 1908 can be evacuated of air or other gas. Spacer 1918 generally determines the height “C” of the interior volume 1908 (e.g., the spacing between the first and the second panes 1904 and 1906). In the example shown in FIG. 19, the thickness (and/or relative thickness) of the ECD, sealant 1920/1922 and bus bars 1926/1928 may not be to scale. These components are generally thin and are exaggerated here, e.g., for ease of illustration only. In some embodiments, the spacing “C” between the first and the second panes 1904 and 1906 is in the range of approximately 6 mm to approximately 30 mm. The width “D” of spacer 1918 can be in the range of approximately 5 mm to approximately 15 mm (although other widths are possible and may be desirable). Spacer 1918 may be a frame structure formed around all sides of the IGU 1900 (for example, top, bottom, left and right sides of the IGU 1900). For example, spacer 1918 can be formed of a foam or plastic material. In some embodiments, spacer 1918 can be formed of metal or other conductive material, for example, a metal tube or channel structure having at least 3 sides, two sides for sealing to each of the substrates and one side to support and separate the lites and as a surface on which to apply a sealant, 1924. A first primary seal 1920 adheres and hermetically seals spacer 1918 and the second surface S2 of the first pane 1904. A second primary seal 1922 adheres and hermetically seals spacer 1918 and the first surface S3 of the second pane 1906. In some implementations, each of the primary seals 1920 and 1922 can be formed of an adhesive sealant such as, for example, polyisobutylene (PIB). In some implementations, IGU 1900 further includes secondary seal 1924 that hermetically seals a border around the entire IGU 1900 outside of spacer 1918. To this end, spacer 1918 can be inset from the edges of the first and the second panes 1904 and 1906 by a distance “E.” The distance “E” can be in the range of approximately four (4) millimeters (mm) to approximately eight (8) mm (although other distances are possible and may be desirable). In some implementations, secondary seal 1924 can be formed of an adhesive sealant such as, for example, a polymeric material that resists water and that adds structural support to the assembly, such as silicone, polyurethane and similar structural sealants that form a water-tight seal.

In the example of FIG. 19, the ECD coating on surface S2 of substrate 1904 extends about its entire perimeter to and under spacer 1918. This configuration is functionally desirable as it protects the edge of the ECD within the primary sealant 1920 and aesthetically desirable because within the inner perimeter of spacer 1918 there is a monolithic ECD without any bus bars or scribe lines.

Configuration examples of IGUs are described in U.S. Pat. No. 8,164,818, issued Apr. 24, 2012 and titled ELECTROCHROMIC WINDOW FABRICATION METHODS (Attorney Docket No. VIEWP006), U.S. patent application Ser. No. 13/456,056 filed Apr. 25, 2012 and titled ELECTROCHROMIC WINDOW FABRICATION METHODS (Attorney Docket No. VIEWP006X1), PCT Patent Application No. PCT/US2012/068817 filed Dec. 10, 2012 and titled THIN-FILM DEVICES AND FABRICATION (Attorney Docket No. VIEWP036WO), U.S. Pat. No. 9,454,053, issued Sep. 27, 2016 and titled THIN-FILM DEVICES AND FABRICATION (Attorney Docket No. VIEWP036US), and PCT Patent Application No. PCT/US2014/073081, filed Dec. 13, 2014 and titled THIN-FILM DEVICES AND FABRICATION (Attorney Docket No. VIEWP036X1WO), each of which is hereby incorporated by reference in its entirety.

In the example shown in FIG. 19, an ECD 1910 is formed on the second surface S2 of the first pane 1904. The ECD 1910 includes an electrochromic (“EC”) stack 1912, which itself may include one or more layers. For example, the EC stack 1912 can include an electrochromic layer, an ion-conducting layer, and a counter electrode layer. The electrochromic layer may be formed of one or more inorganic solid materials. The electrochromic layer can include or be formed of one or more of a number of electrochromic materials, including electrochemically-cathodic or electrochemically-anodic materials. EC stack 1912 may be between first and second conducting (or “conductive”) layers. For example, the ECD 1910 can include a first transparent conductive oxide (TCO) layer 1914 adjacent a first surface of the EC stack 1912 and a second TCO layer 1916 adjacent a second surface of the EC stack 1912. An example of similar EC devices and smart windows can be found in U.S. Pat. No. 8,764,950, titled ELECTROCHROMIC DEVICES, by Wang et al., issued Jul. 1, 2214 and U.S. Pat. No. 9,261,751, titled ELECTROCHROMIC DEVICES, by Pradhan et al., issued Feb. 16, 2216, which is incorporated herein by reference in its entirety. In some implementations, the EC stack 1912 also can include one or more additional layers such as one or more passive layers. For example, passive layers can be used to improve certain optical properties, to provide moisture or to provide scratch resistance. These or other passive layers also can serve to hermetically seal the EC stack 1912.

When a transparent media display is combined with IGU 1900, the media display may be disposed upon second pane 1906 (e.g., with video images projected away from second pane 1906). In other embodiments, the media display is attached (e.g., fastened or adhered to) the IGU. FIG. 19 shows an example of image sensor 1908 mounted in the interior volume of the IGU between first and second panes 1904 and 1906. Such a location for sensor 1908 is unobtrusive and well protected from any harsh environmental conditions (e.g., humidity and/or debris such as dust). Sensor 1908 may be fixed, or a be operatively coupled to an actuator (e.g., a servo-mechanism). The actuator may be provided within the interior volume, e.g., for actively controlling an image capturing location.

In some embodiments, a network infrastructure is provided in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network may comprise one or more levels of encryption. The network may be communicatively coupled to the cloud and/or to one or more servers external to the facility. The network may support at least a fourth generation wireless (4G), or a fifth-generation wireless (5G) communication. The network may support cellular signals external and/or internal to the facility. The downlink communication network speeds may have a peak data rate of at least about 5 Gigabits per second (Gb/s), 10 Gb/s, or 20 Gb/s. The uplink communication network speeds may have a peak data rate of at least about 2 Gb/s, 5 Gb/s, or 10 Gb/s. The network infrastructure can be provided in a facility that includes electrically switchable windows. Examples of components of the network infrastructure include a high speed backhaul. The network infrastructure may include at least one cable, switch, (e.g., physical) antenna, transceivers, sensor, transmitter, receiver, radio, processor and/or controller (that may comprise a processor). The network infrastructure may be operatively coupled to, and/or include, a wireless network. The network infrastructure may comprise wiring (e.g., comprising an optical fiber, twisted cable, or coaxial cable). One or more devices (e.g., sensors and/or emitters) can be deployed (e.g., installed) in an environment, e.g., as part of installing the network infrastructure and/or after installing the network infrastructure. The device(s) may be communicatively coupled to the network. The network may comprise a power and/or communication network. The device can be self-discovered on the network, e.g., once it couples (e.g., on its attempt to couple) to the network. The network structure may comprise peer to peer network structure, or client-server network structure. The network may or may not have a central coordination entity (e.g., server(s) or another stable host). Examples of network, facility, control system, and devices can be found in International Patent Application Serial No. PCT/US21/17946, filed Feb. 12, 2021, titled “DATA AND POWER NETWORK OF A FACILITY,” which is incorporated herein by reference in its entirety.

In some embodiments, a building management system (BMS) is a computer-based control system. The BMS can be installed in a facility to monitor and otherwise control (e.g., regulate, manipulate, restrict, direct, monitor, adjust, modulate, vary, alter, restrain, check, guide, or manage) the facility. For example, the BMS may control one or more devices communicatively coupled to the network. The one or more devices may include mechanical and/or electrical equipment such as ventilation, lighting, power systems, elevators, fire systems, and/or security systems. Controllers (e.g., nodes and/or processors) may be suited for integration with a BMS. A BMS may include hardware. The hardware may include interconnections by communication channels to one or more processors (e.g., and associated software), e.g., for maintaining one or more conditions in the facility. The one or more conditions in the facility may be according to preference(s) set by a user (e.g., an occupant, a facility owner, and/or a facility manager). For example, a BMS may be implemented using a local area network, such as Ethernet. The software can utilize, e.g., internet protocols and/or open standards. One example is software from Tridium, Inc. (of Richmond, Va.). One communication protocol that can be used with a BMS is BACnet (building automation and control networks). A node can be any addressable circuitry. For example, a node can be a circuitry that has an Internet Protocol (IP) address.

In some embodiments, a BMS may be implemented in a facility, e.g., a multi-story building. The BMS may function (e.g., also) to control one or more characteristics of an environment of the facility. The one or more characteristics may comprise: temperature, carbon dioxide levels, gas flow, various volatile organic compounds (VOCs), and/or humidity in a building. There may be mechanical devices that are controlled by a BMS such as one or more heaters, air conditioners, blowers, and/or vents. To control the facility environment, a BMS may turn these various devices on and/or off under defined conditions. A core function of a BMS may be to maintain a comfortable environment for occupants of the environment, e.g., while minimizing heating and cooling costs and/or demand. A BMS can be used to control one or more of the various systems. A BMS may be used to optimize the synergy between various systems. For example, the BMS may be used to conserve energy and lower building operation costs.

In some embodiments, a plurality of devices may be operatively (e.g., communicatively) coupled to the control system. The plurality of devices may be disposed in a facility (e.g., including a building and/or room). The control system may comprise the hierarchy of controllers. The devices may comprise an emitter, a sensor, or a window (e.g., IGU). The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times, the plurality of devices may comprise at least 20, 50, 100, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times, the devices may be in a facility comprising a multi-story building. At least a portion of the floors of the multi-story building may have devices controlled by the control system (e.g., at least a portion of the floors of the multi-story building may be controlled by the control system).

In some embodiments, the facility comprises a multi-story building. The multi-story building may have at least 2, 8, 10, 25, 50, 80, 100, 120, 140, or 160 floors, e.g., that are controlled by the control system and/or comprise the network infrastructure. The number of floors controlled by the control system and/or comprising the network infrastructure may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m²to about 2000 m², from about 150 m² to about 500 m² from about 250 m² to about 1000 m², or from about 1000 m² to about 2000 m²). The building may comprise an area of at least about 1000 square feet (sqft), 2000 sqft, 5000 sqft, 10000 sqft, 100000 sqft, 150000 sqft, 200000 sqft, or 500000 sqft. The building may comprise an area between any of the above mentioned areas (e.g., from about 1000 sqft to about 5000 sqft, from about 5000 sqft to about 500000 sqft, or from about 1000 sqft to about 500000 sqft). The building may comprise an area of at least about 100 m², 200 m², 500 m², 1000 m², 5000 m², 10000 m², 25000 m², or 50000 m². The building may comprise an area between any of the above mentioned areas (e.g., from about 100 m² to about 1000 m², from about 500 m²to about 25000 m², from about 100 m² to about 50000 m²). The facility may comprise a commercial or a residential building. The commercial building may include tenant(s) and/or owner(s). The residential facility may comprise a multi or a single family building. The residential facility may comprise an apartment complex. The residential facility may comprise a single family home. The residential facility may comprise multifamily homes (e.g., apartments). The residential facility may comprise townhouses. The facility may comprise residential and commercial portions. The facility may comprise at least about 1, 2, 5, 10, 50, 100, 150, 200, 250, 300, 350, 400, 420, 450, 500, or 550 windows (e.g., tintable windows). The windows may be divided into zones (e.g., based at least in part on the location, facade, floor, ownership, utilization of the enclosure (e.g., room) in which they are disposed, any other assignment metric, random assignment, or any combination thereof. Allocation of windows to the zone may be static or dynamic (e.g., based on a heuristic). There may be at least about 2, 5, 10, 12, 15, 30, 40, or 46 windows per zone.

In some embodiments, a window controller is integrated with a BMS. For example, the window controller can be configured to control one or more tintable windows (e.g., electrochromic windows). In one embodiment, the one or more electrochromic windows include at least one all solid state and inorganic electrochromic device, but may include more than one electrochromic device, e.g., where each lite or pane of an IGU is tintable. In one embodiment, the one or more electrochromic windows include (e.g., only) all solid state and inorganic electrochromic devices. In one embodiment, the electrochromic windows are multistate electrochromic windows. Examples of tintable windows can be found in, in U.S. patent application Ser. No. 12/851,514, filed on Aug. 5, 2010, and titled “Multipane Electrochromic Windows,” which is incorporated herein by reference in its entirety.

In some embodiments, one or more devices such as sensors, emitters, and/or actuators, are operatively coupled to at least one controller and/or processor. Sensor readings may be obtained by one or more processors and/or controllers. A controller may comprise a processing unit (e.g., CPU or GPU). A controller may receive an input (e.g., from at least one device or projected media). The controller may comprise circuitry, electrical wiring, optical wiring, socket, and/or outlet. A controller may receive an input and/or deliver an output. A controller may comprise multiple (e.g., sub-) controllers. An operation (e.g., as disclosed herein) may be performed by a single controller or by a plurality of controllers. At least two operations may be each preconformed by a different controller. At least two operations may be preconformed by the same controller. A device and/or media may be controlled by a single controller or by a plurality of controllers. At least two devices and/or media may be controlled by a different controller. At least two devices and/or media may be controlled by the same controller. The controller may be a part of a control system. The control system may comprise a master controller, floor (e.g., comprising network controller) controller, or a local controller. The local controller may be a target controller. For example, the local controller may be a window controller (e.g., controlling an optically switchable window), enclosure controller, or component controller. The controller may be a part of a hierarchal control system. They hierarchal control system may comprise a main controller that directs one or more controllers, e.g., floor controllers, local controllers (e.g., window controllers), enclosure controllers, and/or component controllers. The target may comprise a device or a media. The device may comprise an electrochromic window, a sensor, an emitter, an antenna, a receiver, a transceiver, or an actuator.

In some embodiments, the network infrastructure is operatively coupled to one or more controllers. In some embodiments, a physical location of the controller type in the hierarchal control system changes. A controller may control one or more devices (e.g., be directly coupled to the devices). A controller may be disposed proximal to the one or more devices it is controlling. For example, a controller may control an optically switchable device (e.g., IGU), an antenna, a sensor, and/or an output device (e.g., a light source, sounds source, smell source, gas source, HVAC outlet, or heater). In one embodiment, a floor controller may direct one or more window controllers, one or more enclosure controllers, one or more component controllers, or any combination thereof. The floor controller may comprise a floor controller. For example, the floor (e.g., comprising network) controller may control a plurality of local (e.g., comprising window) controllers. A plurality of local controllers may be disposed in a portion of a facility (e.g., in a portion of a building). The portion of the facility may be a floor of a facility. For example, a floor controller may be assigned to a floor. In some embodiments, a floor may comprise a plurality of floor controllers, e.g., depending on the floor size and/or the number of local controllers coupled to the floor controller. For example, a floor controller may be assigned to a portion of a floor. For example, a floor controller may be assigned to a portion of the local controllers disposed in the facility. For example, a floor controller may be assigned to a portion of the floors of a facility. A master controller may be coupled to one or more floor controllers. The floor controller may be disposed in the facility. The master controller may be disposed in the facility, or external to the facility. The master controller may be disposed in the cloud. A controller may be a part of, or be operatively coupled to, a building management system. A controller may receive one or more inputs. A controller may generate one or more outputs. The controller may be a single input single output controller (SISO) or a multiple input multiple output controller (MIMO). A controller may interpret an input signal received. A controller may acquire data from the one or more components (e.g., sensors). Acquire may comprise receive or extract. The data may comprise measurement, estimation, determination, generation, or any combination thereof. A controller may comprise feedback control. A controller may comprise feed-forward control. Control may comprise on-off control, proportional control, proportional-integral (PI) control, or proportional-integral-derivative (PID) control. Control may comprise open loop control, or closed loop control. A controller may comprise closed loop control. A controller may comprise open loop control. A controller may comprise a user interface. A user interface may comprise (or operatively coupled to) a keyboard, keypad, mouse, touch screen, microphone, speech recognition package, camera, imaging system, or any combination thereof. Outputs may include a display (e.g., screen), speaker, or printer. In some embodiments, a local controller controls one or more devices and/or media (e.g., media projection). For example, a local controller can control one or more IGUs, one or more sensors, one or more output devices (e.g., one or more emitters), one or more media, or any combination thereof.

In some embodiments, a BMS includes a multipurpose controller. By incorporating feedback (e.g., of the controller), a BMS can provide, for example, enhanced: 1) environmental control, 2) energy savings, 3) security, 4) flexibility in control options, 5) improved reliability and usable life of other systems (e.g., due to decreased reliance thereon and/or reduced maintenance thereof), 6) information availability and/or diagnostics, 7) higher productivity from personnel in the building (e.g., staff), and various combinations thereof. These enhancements may derive automatically controlling any of the devices. In some embodiments, a BMS may not be present. In some embodiments, a BMS may be present without communicating with a master network controller. In some embodiments, a BMS may communicate with a portion of the levels in the hierarchy of controllers. For example, the BMS may communicate (e.g., at a high level) with a master network controller. In some embodiments, a BMS may not communicate with a portion of the levels in the hierarchy of controllers of the control system. For example, the BMS may not communicate with the local controller and/or intermediate controller. In certain embodiments, maintenance on the BMS would not interrupt control of the devices communicatively coupled to the control system. In some embodiments, the BMS comprises at least one controller that may or may not be part of the hierarchical control system.

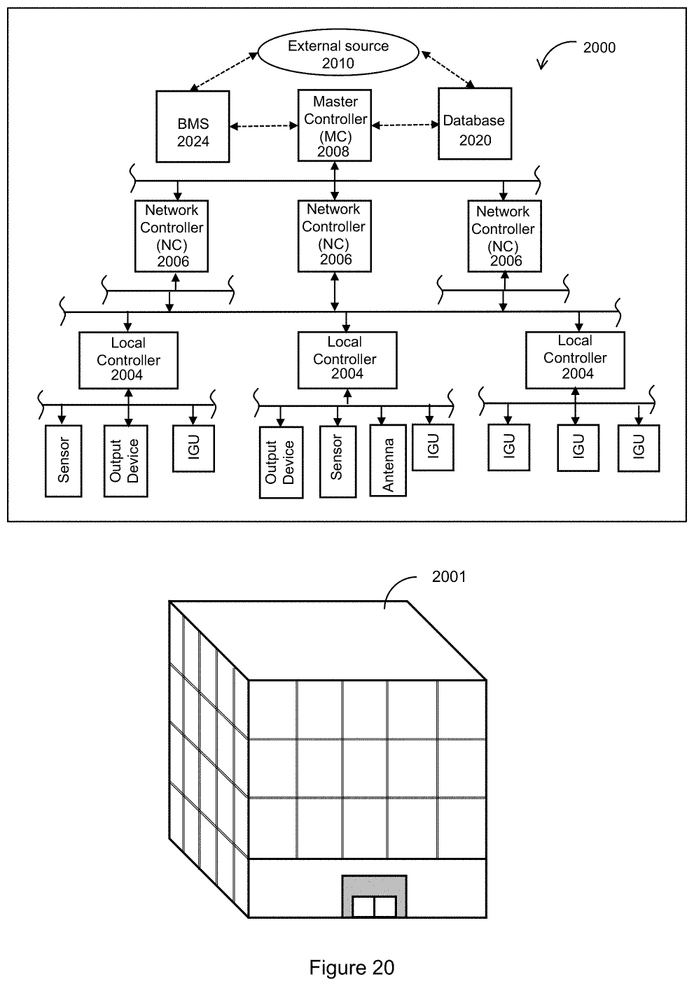

FIG. 20 shows an example of a control system architecture 2000 disposed at least partly in an enclosure (e.g., building) 2001. Control system architecture 2000 comprises a master controller 2008 that controls floor controllers (e.g., network controllers) 2006, that in turn control local controllers 2004. In the example shown in FIG. 20, a master controller 2008 is operatively coupled (e.g., wirelessly and/or wired) to a building management system (BMS) 2024 and to a database 2020. Arrows in FIG. 20 represents communication pathways. A controller may be operatively coupled (e.g., directly/indirectly and/or wired and/wirelessly) to an external source 2010. Master controller 2008 may control floor controllers that include network controllers 2006, that may in turn control local controllers such as window controllers 2004. Floor controllers 2006 may also be include network controllers (NC). In some embodiments, the local controllers (e.g., 2004) control one or more targets such as IGUs, one or more sensors, one or more output devices (e.g., one or more emitters), media, or any combination thereof. The external source may comprise a network. The external source may comprise one or more sensor or output device. The external source may comprise a cloud-based application and/or database. The communication may be wired and/or wireless. The external source may be disposed external to the facility. For example, the external source may comprise one or more sensors and/or antennas disposed, e.g., on a wall or on a ceiling of the facility. The communication may be monodirectional or bidirectional. In the example shown in FIG. 20, the communication all communication arrows are meant to be bidirectional.

In some embodiments, a controller or other network device includes a sensor or sensor ensemble. For example, a plurality of sensors or a sensor ensemble may be organized into a sensor module. A sensor ensemble may comprise a circuit board, such as a printed circuit board, e.g., in which a number of sensors are adhered or affixed to the circuit board. Sensor(s) can be removed from a sensor module. For example, a sensor may be plugged into and/or unplugged out of, the circuit board. Sensor(s) may be individually activated and/or deactivated (e.g., using a switch). The circuit board may comprise a polymer. The circuit board may be transparent or non-transparent. The circuit board may comprise metal (e.g., elemental metal and/or metal alloy). The circuit board may comprise a conductor. The circuit board may comprise an insulator. The circuit board may comprise any geometric shape (e.g., rectangle or ellipse). The circuit board may be configured (e.g., may be of a shape) to allow the ensemble to be disposed in frame portion such as a mullion (e.g., of a window). The circuit board may be configured (e.g., may be of a shape) to allow the ensemble to be disposed in a frame (e.g., door frame and/or window frame). The frame may comprise one or more holes, e.g., to allow the sensor(s) to obtain (e.g., accurate) readings. The circuit board may be enclosed in a wrapping. The wrapping may comprise flexible or rigid portions. The wrapping may be flexible. The wrapping may be rigid (e.g., be composed of a hardened polymer, from glass, or from a metal (e.g., comprising elemental metal or metal alloy). The wrapping may comprise a composite material. The wrapping may comprise carbon fibers, glass fibers, and/or polymeric fibers. The wrapping may have one or more holes, e.g., to allow the sensor(s) to obtain (e.g., accurate) readings. The circuit board may include an electrical connectivity port (e.g., socket). The circuit board may be connected to a power source (e.g., to electricity). The power source may comprise renewable and/or non-renewable power source.

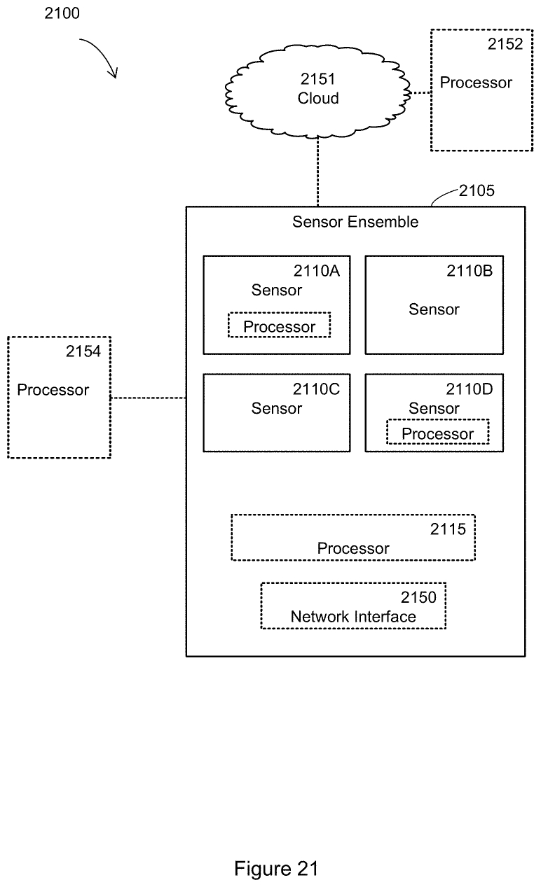

FIG. 21 shows an example of diagram 2100 having an example of an ensemble of sensors organized into a sensor module. Sensors 2110A, 2110B, 2110C, and 2110D are shown as included in sensor ensemble 2105. An ensemble of sensors organized into a sensor module may include at least 1, 2, 4, 5, 8, 10, 20, 50, or 500 sensors. The sensor module may include a number of sensors in a range between any of the aforementioned values (e.g., from about 1 to about 1000, from about 1 to about 500, or from about 500 to about 1000). Sensors of a sensor module may comprise sensors configured and/or designed for sensing a parameter comprising: temperature, humidity, carbon dioxide, particulate matter (e.g., between 2.5 μm and 10 μm), total volatile organic compounds (e.g., via a change in a voltage potential brought about by surface adsorption of volatile organic compound), ambient light, audio noise level, pressure (e.g., gas, and/or liquid), acceleration, time, radar, lidar, radio signals (e.g., ultra-wideband radio signals), passive infrared, glass breakage, or movement detectors. The sensor ensemble (e.g., 2105) may comprise non-sensor devices, such as buzzers and light emitting diodes. Examples of sensor ensembles and their uses can be found in U.S. patent application Ser. No. 16/447,169 filed Jun. 20, 2019, titled “SENSING AND COMMUNICATIONS UNIT FOR OPTICALLY SWITCHABLE WINDOW SYSTEMS” that is incorporated herein by reference in its entirety.

In some embodiments, an increase in the number and/or types of sensors may be used to increase a probability that one or more measured property is accurate and/or that a particular event measured by one or more sensor has occurred. In some embodiments, sensors of sensor ensemble may cooperate with one another. In an example, a radar sensor of sensor ensemble may determine presence of a number of individuals in an enclosure. A processor (e.g., processor 2115 such as a microprocessor) may determine that detection of presence of a number of individuals in an enclosure is positively correlated with an increase in carbon dioxide concentration. In an example, the processor-accessible memory may determine that an increase in detected infrared energy is positively correlated with an increase in temperature as detected by a temperature sensor. In some embodiments, network interface (e.g., 650) may communicate with other sensor ensembles similar to sensor ensemble. The network interface may additionally communicate with a controller.

Individual sensors (e.g., sensor 2110A, sensor 2110D, etc.) of a sensor ensemble may comprise and/or utilize at least one dedicated processor. A sensor ensemble may utilize a remote processor (e.g., 2154) utilizing a wireless and/or wired communications link. A sensor ensemble may utilize at least one processor (e.g., processor 2152), which may represent a cloud-based processor coupled to a sensor ensemble via the cloud (e.g., 2151). Processors (e.g., 2152 and/or 2154) may be located in the same building, in a different building, in a building owned by the same or different entity, a facility owned by the manufacturer of the window/controller/sensor ensemble, or at any other location. In various embodiments, as indicated by the dotted lines of FIG. 21, sensor ensemble 2105 is not required to comprise a separate processor and network interface. These entities may be separate entities and may be operatively coupled to ensemble 2105. The dotted lines in the example shown in FIG. 21 designate optional features. In some embodiments, onboard processing and/or memory of one or more ensemble of sensors may be used to support other functions (e.g., via allocation of ensembles(s) memory and/or processing power to the network infrastructure of a building).

In some embodiments, sensor data is exchanged among various network devices and controllers. The sensor data may also be accessible to remote users (e.g., inside or outside the same building) for retrieval using personal electronic devices, for example. Applications executing on remote devices to access sensor data may also provide commands for controllable functions such as tint commands for a window controller. An example window controller(s) is described in PCT Patent Application No. PCT/US16/58872, titled CONTROLLERS FOR OPTICALLY-SWITCHABLE DEVICES, filed Oct. 26, 2016, and in U.S. patent application Ser. No. 15/334,832, titled CONTROLLERS FOR OPTICALLY-SWITCHABLE DEVICES, filed Oct. 26, 2016, each of which is herein incorporate by reference in its entirety.

The methods, systems and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. A plurality of devices (e.g., sensors and/or emitters) may be disposed in a container and may constitute an ensemble (e.g., a digital architectural element). The ensemble may comprise at least two devices of the same type. The ensemble may comprise at least two devices of a different type. The devices in the ensemble may be operatively coupled to the same electrical board. The electrical board may comprise circuitry. The electrical board may comprise, or be operatively coupled to a controller (e.g., a local controller). The control system may control the one or more devices (e.g., sensors). The control system may control one or more components of a building management system (e.g., lightening, security, and/or air conditioning system). The controller may regulate at least one (e.g., environmental) characteristic of the enclosure. The control system may regulate the enclosure environment using any component of the building management system. For example, the control system may regulate the energy supplied by a heating element and/or by a cooling element. For example, the control system may regulate velocity of an air flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one component of the forming systems and/or apparatuses disclosed herein. Examples of a digital architectural element can be found in PCT patent application serial number PCT/US20/70123 that is incorporated herein by reference in its entirety.

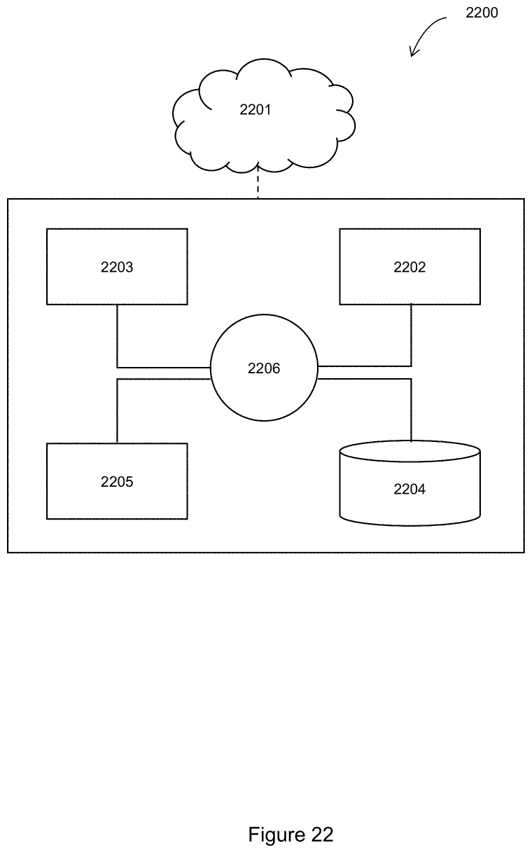

FIG. 22 shows a schematic example of a computer system 200 that is programmed or otherwise configured to one or more operations of any of the methods provided herein. The computer system can control (e.g., direct, monitor, and/or regulate) various features of the methods, apparatuses, and systems of the present disclosure, such as, for example, control heating, cooling, lightening, and/or venting of an enclosure, or any combination thereof. The computer system can be part of, or be in communication with, any sensor or sensor ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

The computer system can include a processing unit (e.g., 2206) (also “processor,” “computer” and “computer processor” used herein). The computer system may include memory or memory location (e.g., 2202) (e.g., random-access memory, read-only memory, flash memory), electronic storage unit (e.g., 2204) (e.g., hard disk), communication interface (e.g., 2203) (e.g., network adapter) for communicating with one or more other systems, and peripheral devices (e.g., 2205), such as cache, other memory, data storage and/or electronic display adapters. In the example shown in FIG. 22, the memory 2202, storage unit 2204, interface 2203, and peripheral devices 2205 are in communication with the processing unit 2206 through a communication bus (solid lines), such as a motherboard. The storage unit can be a data storage unit (or data repository) for storing data. The computer system can be operatively coupled to a computer network (“network”) (e.g., 2201) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 2202. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 2200 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 2202 or electronic storage unit 2204. The machine executable or machine-readable code can be provided in the form of software. During use, the processor 2206 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion. In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein. The controller may be operatively (communicatively) coupled to control logic (e.g., code embedded in a software) in which its operation(s) are embodied.

In one or more aspects, one or more of the functions described herein may be implemented in hardware, digital electronic circuitry, analog electronic circuitry, computer software, firmware, including the structures disclosed in this specification and their structural equivalents thereof, or in any combination thereof. Certain implementations of the subject matter described in this document also can be implemented as one or more controllers, computer programs, or physical structures, for example, one or more modules of computer program instructions, encoded on a computer storage media for execution by, or to control the operation of window controllers, network controllers, and/or antenna controllers. Any disclosed implementations presented as or for electrochromic windows can be more generally implemented as or for switchable optical devices (including windows, mirrors, etc.).

Various modifications to the embodiments described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the devices as implemented.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this does not necessarily mean that the operations are required to be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

In some embodiments, the network infrastructure is configured to operatively couple to one or more (e.g., an array of) chargers. The charger can be disposed in the interior of the framing or framing cap portion. The chargers may be wireless chargers in the sense that they do not require wiring into the device they are charging (e.g., a transitory circuitry such as a mobile phone, pad, laptop, a tag (e.g., and ID tag), or any other charge requiring device such as one comprising a transitory processor). The charging devices may electrically charge the transitory circuitry. The charging device may be disposed in a transom (also known as “horizontal mullion”). The charging device may be disposed in any real asset that operatively (e.g., electronically) coupled to the network (e.g., local network of a facility), and that is configured to facilitate wireless charging, e.g., on at least one of its surfaces. The charging device may comprise an electromagnetic induction charging for transitory circuitry (e.g., mobile device). In some embodiments, the transitory circuitry (e.g., mobile device) to be wirelessly charge is configured for (e.g., enables) wireless charging. The wireless charging may or may not require contact of the charging device with the device to be charged. The wireless charging device does not require connection of electrical wiring between the charging device and the device to be charged (e.g., the mobile circuitry). The wireless charging may facilitate interaction of facility occupants with fixtures and/or real assets (e.g., furniture) of the facility. The charging stations may be installed as part of the network, e.g., during construction of the facility. If the local network of the facility is the initial network installed in the facility, the facility may be opened to occupants with such wireless charging devices on its first day of opening. Usage of charging station may reduce the number of required outlets in the facility, and/or free outlets for usage other than mobile device charging, thus potentially increasing the aesthetics of the facility fixtures, allowing more design flexibility of the facility interior, and increase the usage of fixtures and/or real assets of the facility. The infrastructure installed in the building (e.g., including framing systems and network) may include the wireless charging stations (e.g., as part of the framing system or not). In using wireless charging stations in a facility, (a) developers can offer a state of the art building with mobile device wireless charging integrated into the building from day one (1) in convenient, non-obstructive locations and/or (b) occupants will have more and/or easier access locations to charge their mobile devices (e.g., without wires getting in their way and/or taking up much needed outlets). Developers may wish to create connected spaces that are built to the requests of occupants to increasingly utilize mobile devices, and/or allow seamless and easy charging. Wireless charging may require a user to place the mobile device on the wireless charging stations without more.

In some embodiments, a real asset and/or a fixtures (e.g., a framing portion such as a transom) may comprise a material that facilitates wireless charging therethrough. For example, a material that facilitate (e.g., has no or reduced blockage of) electromagnetic field. When the real asset and/or fixture is made of a material with diminished ability to facilitate wireless charging, the real asset and/or fixture may have a portion having a material that facilitates wireless charging. For example, a transom made of metal (e.g., Aluminum), may have a portion (e.g., break portion) made of a material that facilitates wireless charging (e.g., a non-metallic material). The material may constitute an electrical break area that is configured to facilitate wireless charging (e.g., electromagnetic induction) technology. For example, the real asset and/or fixture may have at least one portion of a material that is configured for reduced blockage of (e.g., does not block) the electromagnetic field from penetrating therethrough from the charging device to the charged device.

In some embodiments, the wireless charging station is in a framing portion supporting one or more display constructs. For example, when a user views media projected by the display construct, the user may place his mobile device on a transom (e.g., near the wireless charging device) while watching the media, and the mobile device of the user may be (e.g., seamlessly) charged during that time. The wireless charging may require placement of the mobile device adjacent to (e.g., on top of, beneath, or to the side of) the charging device.

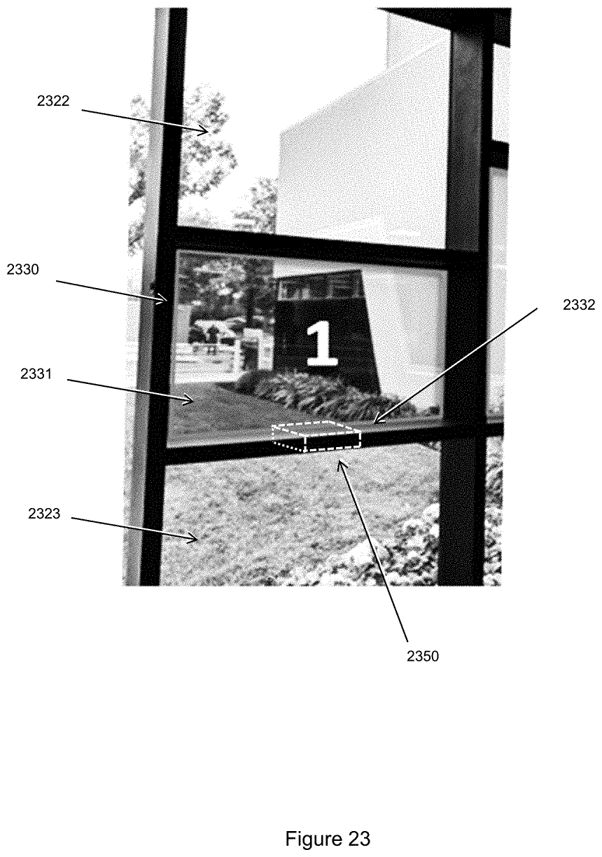

FIG. 23 shows an example of a charging station embedded in a fixture of a facility. Display construct 2331 (also indicated as #1) is disposed in a framing system having a mullion 2330 and a transom 2332. The framing station holds the display construct 2331 and windows such as 2322 and 2332. The transom 2332 includes charging device in its interior in the area 2350, which charging device is coupled to the network (e.g., the same network to which the display construct 2331 is coupled to). Transom 2332 includes a wireless charging station in the exterior of transom 2332, in area 2350. The area of the charging station may extend beyond 2350, e.g., depending on the charging capability (e.g., range) of the wireless charging device. A user watching media displayed by display construct 2331 may rest the device to be charged (e.g., mobile device) on the transom while watching the displayed media, thus allowing seamless charging of the device to be charged (e.g., provided the device to be charged is configured for wireless charging). The device to be charged can be wirelessly charged regardless of the user using the display construct. At least one of the windows (e.g., 2322 and 2323) may or may not be tintable windows. At least one of the windows (e.g., 2322 and 2323) may or may not be smart windows such as electrochromic windows.

In some embodiments, the local network is operatively coupled to wireless charging device. The wireless charging may comprise inductive charging. The wireless charging may be cordless charging. The wireless charging may facilitate contactless (e.g., cordless) charging between the charging device and the device to be charged. For example, the wireless charging may be devoid of a requirement to make electrical contact with the charging device or any intermediary thereto (e.g., a docking station or a plug). The wireless charging may facilitate wireless transfer of electrical power. The wireless charging may utilize electromagnetic induction to provide electricity to devices to be charged, e.g., portable (e.g., transitory) devices. The transitory device may comprise vehicles, power tools, electric dental equipment (e.g., toothbrushes), or any other medical devices. The portable device may or may not require precise alignment with the charging device (e.g., charging pad). The wireless charging may transfer energy through inductive coupling. The wireless charging may include passing an alternating current through an induction coil in the charging device (e.g., charging pad). The wireless charging may include generating a magnetic field. The magnetic field may fluctuate in strength (e.g., when an amplitude of the alternating electric current is fluctuating). This changing magnetic field may create an alternating electric current in an induction coil of the portable device (e.g., mobile device). The alternating current in the induction coil may pass through a rectifier, e.g., to convert it to a direct current. The direct current may charge a battery and/or provide operating power of the portable device (e.g., transitory circuitry).

In some embodiments, the wireless charging device (e.g., also used here as wireless charge or inductive charger) utilizes resonant inductive coupling. The charging device may comprise a capacitor, e.g., to one or more (e.g., to each of the) induction coils. The addition of the capacitor may create two low current circuits with a (e.g., specific) resonance frequency. The frequency of the alternating current may be matched with the resonance frequency. The frequency may be chosen, e.g., depending on the distance requested for peak efficiency. For example, depending on the distance between the charging device and the designated placement of the device to be charged. For example, depending on the material(s) disposed between the charging device and the designated placement of the device to be charged. The charging device may comprise a movable transmission coil. The charging device and/or device to be charged may comprise a receiver coil such as silver-plated copper or aluminum (e.g., to minimize weight and/or decrease resistance such as due to skin effects).

In some embodiments the wireless charging device is a high power charging device. In some embodiments the wireless charging device is a low power charging device. The low power charging device may be configured to charge small electronic devices such as cell phones, handheld devices, computers (e.g., laptops). The low power charging device may be configured to charge at power levels of at most about 50 watts (W), 100 W, 150 W, 200 W, 250 W, 300 W, 350 W, 400 W, 450 W, or 500 W. The low power charging device may be configured to charge at power levels between any of the aforementioned power levels (e.g., from about 50 W to about 100 W, from about 100 W to about 500 W, or from about 50 W to about 500 W). The high power charging device may be configured to charge at power levels of at least about 700 W, one (1) kilowatt (KW), 10 KW, 11 KW, 100 KW, 200 KW, 300 KW, or 500 KW. The high power charging device may be configured to charge at power levels between any of the aforementioned power levels (e.g., from about 700 W to about 500 KW, from about 700 W to about 10 KV, or from about 1 KW to about 500 KW).

In some embodiments, the wireless charging stations may provide advantages over wired charging stations. For example, in wireless charging there is a lower risk of electrical faults such as due to corrosion, electrocution, and wiring tangling. For example, in wireless charging there is an absence of wear and tear damage of electrical connectors, sockets and/or wiring, e.g., since no wiring and connection is required between the charging device and the device to be charge. For example, wireless charging offers an increased usage convenience and/or facility aesthetics. For example, wireless charging offers convenient frequent charging. The wireless charging may allow for dynamic charging, e.g., charging the mobile device while it is in motion (e.g., depending on the capacity of the charging device). When medical devices are to be charged, wireless charging may reduce the infection risk, e.g., by eliminating a requirement to connect to electricity outlets and/or wiring used by multiple users. The charging speed can be of 1, 2 or 3 wireless power transfer (WPT) class, e.g., as defined by the Society of Automotive Engineers (SAE) International. The wireless charging may be at a distance of at most about 1 centimeter (cm), 2 cm, 4 cm, 5 cm, 8 cm, 10 cm, 25 cm, 50 cm, 75 cm, 100 cm, 250 cm, 500 cm, 750 cm, 900 cm, or 1000 cm from the charging device. The wireless charging may be at a distance from the charging device between any of the aforementioned values (e.g., from about 1 cm to about 10 cm, from about 1 cm to about 50 cm, from about 1 cm to about 100 cm, or from about 1 cm to about 1000 cm). The wireless charging may be at a distance of at most about 1 inches (″), 1.5″, 1.6, 6″ or 12″ from the charging device. The wireless charging may be at a distance from the charging device between any of the aforementioned values (e.g., from about 1″ to about 12″). The wireless charging may be at a distance of at most about 5 feet 0, 10′, 20′, 30′, 40′ or 50′ from the charging device. The wireless charging may be at a distance from the charging device between any of the aforementioned values (e.g., from about 5′ to about 50′).

In some embodiments, the charging device may abide by at least one standard (e.g., protocol) accepted in the jurisdiction. The standard may comprise Qi or Power Matter Alliance (PMA) standard. The standard may comprise J1773 (Mange charge), SAE J2954, AirFuel Alliance, Alliance for Wireless Power (A4WP, or Rezence), or ISO 15118 standard. The standard may define a frequency and/or a connection protocol. The charging device may be configured to compile with a plurality (e.g., all) standards accepted in the jurisdiction. The standard may be an open interface standard. The standard may be a wireless power transfer standard. The standard may be a Wireless Power Consortium standard. The standard may be an Institute of Electrical and Electronics Engineers standard. The standard may be an AirFuel alliance standard (e.g., combining A4WP and PMA). The standard may be a road vehicle standard.

In some embodiments, the charging device is operatively coupled to the network and/or control system of the facility. The charging device may be controlled by the control system. For example, the control system may schedule shutting off or on the charging device. The control system may control the operating mode of the charging device. The control system may be integrated or separate from the control system of the facility. The charging device may be additionally or alternatively manually controlled (e.g., by a user), e.g., through an application module. The application module of the charging device may comprise a graphic user interface (GUI). The application module may be configured to receive user input. The application module may be configured for installation of the device to be charged. The application module may be configured for installation of a device coupled to the network of the facility. The charging device may be discoverable by the network. The network may be operatively (e.g., communicatively) coupled to a Building Information Modeling (BIM) (e.g., Revit file) of the facility. Location and/or status of the charging device(s) coupled to the network may be updated (e.g., intermittently or in real time) to the network, e.g., and to the BIM file. The application module may indicate the location, operational mode, and/or status of the charging device. The GUI may depict a location, operational mode, and/or status of the charging device in the BIM file of the facility. The GUI may indicate location of the user and/or device to be charged, which location is with respect to the facility (e.g., of an enclosure such as a room of the facility), for example, as depiction in the BIM file. The GUI may show a simplistic version (e.g., with lower level of details such as a select level of details) than the details available in the BIM file. For example, the application module may show fixtures and select devices (e.g., charging devices and media displays) of the facility.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method for digital collaboration, the method comprising:
(A) establishing a communication link between (i) a first processor operatively coupled to a first media display and associated sensor disposed at a first location occupied by at least one first user and (ii) a second processor operatively coupled to a second media display disposed at a second location occupied by at least one second user; and
(B) displaying, with the first media display at the first location, a media stream from the second processor communicated to the first media display via the communication link, wherein a portion of the media stream is suppressed from being displayed on the first media display that is at least partially transparent to visible light, which suppression enables viewing at least a portion of the first location through a portion of the first media display corresponding to the media stream that is suppressed.

2. The method of claim 1, wherein the second processor is operatively coupled to another sensor configured to capture to at least one second user in the second location.

3. (canceled)

4. The method of claim 1, wherein the portion of the media stream which is suppressed comprises a region around another portion of the media stream which depicts the second user.

5. The method of claim 1, wherein the first media display comprises a transparent display, and wherein the portion of the media stream which is suppressed facilitates at least partial viewing of the first location of the first user through the transparent display.

6. (canceled)

7. (canceled)

8. The method of claim 5, wherein the first media display is coupled to a tintable window.

9.-22. (canceled)

23. The method of claim 1, further comprising (C) displaying on the first media display at least one virtual object which depicts a furnishing that spatially appears to be disposed between (i) the first user and (ii) the media stream displayed on the first media display.

24. The method of claim 23, wherein the at least one virtual object is displayed so that it provides an apparent depth which is in front of an apparent depth of the depiction of the second user.

25.-44. (canceled)

45. The method of claim 1, further comprising displaying on the first media display and/or the second media display a shared auxiliary content at a region of the first media display and/or at a region of the second media display.

46.-54. (canceled)

55. The method of claim 1, further comprising displaying, with the second media display at the second location, an other media stream of the at least the one first user sent to the second media display from the first media display via the communication link, wherein a first portion of the other media stream is suppressed from being displayed on the second media display that is at least partially transparent to visible light, to facilitate viewing of at least a portion of the second location through a portion of the second media display corresponding to the other media stream that is suppressed.

56. (canceled)

57. (canceled)

58. An apparatus for digital collaboration, the apparatus comprising at least one controller configured to:
(A) operatively couple to a first processor that is operatively coupled to a first media display disposed at a first location occupied by at least one first user, which operatively coupling of the first processor is via a communication link to a second processor that is operatively coupled to a second media display disposed at a second location occupied by at least one second user; and
(B) direct the first media display to display a media stream of the at least one second user sent to the first processor from the second processor via the communication link, wherein a first portion of the media stream is suppressed from being displayed on the first media display that is at least partially transparent to visible light, which suppression enables viewing of at least a portion of the first location through a portion of the first media display corresponding to the media stream that is suppressed.

59. (canceled)

60. The apparatus of claim 58, wherein the first processor is included in a control system which comprises, or is operatively coupled to, a building management system.

61. (canceled)

62. The apparatus of claim 58, wherein the first processor is included in a control system which comprises a hierarchical control system in which a master controller is configured to control one or more local controllers.

63.-67. (canceled)

68. The apparatus of claim 58, further comprising a tintable window which alters visibility, color, transmission, and/or reflectance of visible light, wherein the first processor is configured for adjusting a tint of the tintable window.

69. (canceled)

70. (canceled)

71. (canceled)

72. A non-transitory computer readable product instructions for digital collaboration, the non-transitory computer readable product instructions, when read by one or more processors, cause the one or more processors to execute one or more operations, comprising: directing a first media display disposed at a first location, to display a media stream of the at least one second user disposed at a second location, which media stream is sent to a first processor operatively coupled to the first media display, from a second processor operatively coupled to the second media display, which media stream is sent via a communication link, wherein a first portion of the media stream is suppressed from the displaying on the first media display that is at least partially transparent to visible light, which suppression enables viewing of at least a portion of the first location through a portion of the first media display corresponding to the media stream that is suppressed,
which one or more processors are operatively coupled to the first processor that is operatively coupled to the first media display disposed at the first location occupied by at least one first user, which operatively coupling of the first processor is via the communication link to the second processor operatively coupled to the second media display disposed at the second location occupied by the at least one second user.

73. (canceled)

74. The non-transitory computer readable product instructions of claim 72, wherein the product instructions are included in a program product.

75. (canceled)

76. (canceled)

77. A system for digital collaboration, the system comprising:
a network configured to:
(a) operatively couple to a first media display disposed at a first location occupied by at least one first user, which first media display is operatively coupled to a first processor;
a second media display disposed at a second location occupied by at least one second user, which second media display is operatively coupled to a second processor; and
(b) facilitate a communication link between the first processor and the second processor, which communication link is configured to transmit the media stream transmitted to the first media display, wherein a first portion of the media stream is suppressed from being displayed on the first media display that is at least partially transparent to visible light, which suppression enables viewing of at least a portion of the first location through a portion of the first media display corresponding to the media stream that is suppressed.

78. (canceled)

79. The system of claim 77, wherein the network is operatively coupled to a hierarchical control system at least partially disposed in an enclosure which includes the first location.

80. (canceled)

81. The system of claim 77, wherein the network is at least partly disposed in a facility and is capable of transmitting power and communication signals.

82. The system of claim 81, wherein the network is configured to connect to a plurality of devices in the facility.

83. (canceled)

84. (canceled)

85. (canceled)

86. The system of claim 82, wherein the plurality of devices includes a controller operatively coupled to control a lighting device, a tintable window, a sensor, an emitter, a media display, a dispenser, a processor, a power source, a security system, a fire alarm system, a sound media, an antenna, a radar, a controller, a heater, a cooler, a vent, or a heating ventilation and air conditioning system (HVAC).

87.-161. (canceled)
